(19) United States
(12) Patent Application Publication
(10) Pub. No.: US 2023/0344278 A1
(43) Pub. Date: Oct. 26, 2023

(54) WIRELESS CHARGING METHOD AND SYSTEM WITH FINANCIAL TRANSACTION

(71) Applicant: Wireless Electrical Grid LAN, WiGL Inc., Hampton, VA (US)

(72) Inventor: Ahmad L.D. Glover, Hampton, VA (US)

(73) Assignee: Wireless Electrical Grid LAN, WiGL Inc., Hampton, VA (US)

(21) Appl. No.: 18/215,774

(22) Filed: Jun. 28, 2023

Related U.S. Application Data
(63) Continuation-in-part of application No. 18/120,782, filed on Mar. 13, 2023.
Application No. 18/120,782 is a continuation of application No. 17/033,824, filed on Sep. 27, 2020, now Pat. No. 11,605,983.
Application No. 17/033,824 is a continuation-in-part of application No. 17/019,312, filed on Sep. 13, 2020, now Pat. No. 11,557,927.
Application No. 17/019,312 is a continuation-in-part of application No. 16/482,347, filed on Jul. 31, 2019, now Pat. No. 10,992,158.
Application No. 16/482,347 is a continuation-in-part of application No. 15/640,574, filed on Jul. 2, 2017, now Pat. No. 9,985,465.
(60) Provisional application No. 62/506,737, filed on May 16, 2017.

(51) Int. Cl. H02J 7/00; H02J 50/20; H02J 7/02

(52) U.S. Cl. CPC H02J 50/20; H02J 7/00032; H02J 7/0048; H02J 7/02

(57) ABSTRACT

A method of providing wireless energy which includes determining a status of a power receiver and/or of an electronic device in communication with the power receiver via bidirectional electronic communication between the wireless charging system and the power receiver and/or between the wireless charging system and the electronic device; transferring wireless energy from the wireless charging system to the power receiver; converting the wireless energy into electrical energy; and directing at least a portion of the electrical energy into a power storage assembly, and/or directly to the electronic device; wherein the transferring of the wireless energy comprises a financial transaction between a wireless energy provider and an end user of the electronic device. A wireless charging system is also disclosed.

### CROSS REFERENCE TO RELATED APPLICATIONS

For purposes of US practice, the present application is a Continuation in Part of U.S. Pat. App. 18/120782, filed Mar. 13, 2023, which is a Continuation of U.S. Pat. App. 17/033,824, filed Sep. 27, 2020; which is a Continuation in Part of U.S. Pat. App. 17/019,312, filed Sep. 13, 2020; which is a Continuation in Part of U.S. Pat. App. 16/482,347, filed Jul. 31, 2019, now US 10,992,158 issued Apr. 27, 2021, which is a 35 U.S.C. §371 National Stage patent application of International Pat. App. PCT/US18/15625, filed on Jan. 28, 2018, which is a Continuation in Part of U.S. Pat App. 15/640,574, filed Jul. 2, 2017, now U.S. 9,985,465 issued May 29, 2018, all of which claim priority to U.S. Provisional Pat. App. 62/506737, filed May 16, 2017. The disclosures of all the above patents, provisional applications and non-provisional patent applications are hereby incorporated herein by reference.

### BACKGROUND

This invention relates to a wireless charging method and system for charging an electronic power-consuming device. An Internet Of Think (IoT) device, a home appliance, or the like.

Use of the electromagnetic spectrum, such as microwave, light, laser and/or radio frequency (RF) technologies are beginning to enable transformative changes in our society via innovations such as wireless communication, radio wave sensing and wireless power transfer. In relation to the power needs of mobile devices, electromagnetic RF technologies offer a new vision of wirelessly powered world. This can be realized through a wireless power transmission grid, which could be applied for a range of applications from traditional mobile phones to wearable health and fitness devices, implantable devices, and other Internet of Things (IoT) type devices. This vision is specially becoming true on account of ever reducing power usage of modern electronics and innovations in rechargeable batteries.

Because of the growth of mobile computing and wearables, the demand for wireless sources of power is increasing for the scenarios where cable-based charging is not feasible or where the issue of battery depletion and replacement exists.

There is a need in the art for an efficient wireless powering solution to power and/or recharge a device.

### SUMMARY

In one aspect, a method comprises determining a status of a power receiver and/or of an electronic device in communication with the power receiver via bidirectional electronic communication between the wireless charging system and the power receiver and/or between the wireless charging system and the electronic device; transferring wireless energy from the wireless charging system to the power receiver; converting the wireless energy into electrical energy; and directing at least a portion of the electrical energy into a power storage assembly, and/or directly to the electronic device; wherein the transferring of the wireless energy comprises a financial transaction between a wireless energy provider and an end user of the electronic device.

In another aspect, a system comprises a wireless charging system comprising one or more power chargers configured to transfer wireless energy from the wireless charging system to a power receiver in electrical communication with an electronic device; the power receiver configured to receive the wireless energy; convert the wireless energy into electrical energy; and direct at least a portion of the electrical energy into a power storage assembly, and/or direct at least a portion of the electrical energy to the electronic device; the system configured to cause a financial transaction to occur between a wireless energy provider and an end user of the electronic device upon the transferring of wireless energy from the wireless charging system to the power receiver.

### BRIEF DESCRIPTION OF THE DRAWINGS

A wide variety of potential practical and useful embodiments will be understood through the following detailed description of various embodiments, with reference to the accompanying drawings in which:

FIG. 1 is a block diagram of a system according to an embodiment disclosed herein.

FIG. 2 is a block diagram of a method of determining a status according to embodiments disclosed herein.

### DETAILED DESCRIPTION

At the outset, it should be noted that in the development of any such actual embodiment, numerous implementation-specific decisions must be made to achieve the developer’s specific goals, such as compliance with system related and business-related constraints, which will vary from one implementation to another. Moreover, it will be appreciated that such a development effort might be complex and time consuming but would nevertheless be a routine undertaking for those of ordinary skill in the art having the benefit of this disclosure. In addition, the article, construction, and/or system used/disclosed herein can also comprise components other than those cited.

In the summary and this detailed description, each numerical value should be read once as modified by the term “about” (unless already expressly so modified), and then read again as not so modified unless otherwise indicated in context.

For purposes herein, embodiments or a portion of an embodiment are described as “having,” “including” or “comprising” one or more limitations for brevity. However, it is to be understood that for purposes herein, that same sentence is intended to, and should be read again as being modified to include an embodiment described as “consisting essentially” of the one or more limitations, and should be read again as being modified to include an embodiment described as “consisting” of the one or more limitations.

Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specifically, it is to be understood that inventors appreciate and understand that any and all data points within the range are to be considered to have been specified, and that inventors possessed knowledge of the entire range and all points within the range.

It is to be understood that various embodiments of the present disclosure will be described with reference to the accompanying drawings. Accordingly, those of ordinary skill in the art will recognize that modifications, equivalents, and/or alternatives of the various embodiments described herein can be made without departing from the scope and spirit of the present disclosure. With regard to description of drawings, similar components may be marked by similar reference numerals.

For purposes herein, expressions such as, “A or B” represents an alternative selection which, for example, refer to the case (1) where A is included or (2) where B is included, but does not represent the case where both A and B are included. Expressions such as, “A and/or B,” “at least one of A and/or B”, “one or more of A and/or B”, and the like, refer to a case which may include any and all combinations of one or more of the associated listed items. For example, the terms “A and/or B”, and “at least one of A or B” may refer to the case (1) where A is included, (2) where B is included, or (3) where both A and B are included.

Terms such as “first”, “second”, and the like used herein may refer to various elements of various embodiments disclosed herein however, it is to be understood that these labels do not limit the elements to any particular order, amount, or importance; such terms are used only to distinguish one particular element from another element and do not limit the order and/or priority of the elements. For example, a first user device and a second user device may represent different user devices irrespective of sequence or importance. Likewise, such terms are used relative to others and do not represent absolute location, place, or order. For example, without departing from the scope of the present disclosure, a first element of one embodiment may be referred to as a second element in another embodiment, and similarly, a second element may be referred to as a first element.

Likewise, unless explicitly indicated, in a process comprising a first step and a second step, the steps may be undertaken in any order, e.g., the first step followed by the second step, or the second step followed by the first step. Stated another way, the methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It will be understood that when an element (for example, a first element) is referred to as being coupled, configured, operatively or communicatively “coupled with/to” or “connected to” another element (for example, a second element), it can be directly coupled with/to or connected to the other element or an intervening element (for example, a third element or more) may be present between the two elements disclosed. For example, if object A physically touches object B, and object B touches object C, then objects A and C may still be considered coupled to one another-even if they do not directly physically touch each other. Stated another way, a first object may be coupled to a second object even though the first object is never directly physically in contact with the second object.

As used herein, the expression “configured to” used herein may be used interchangeably with, for example, the expression “suitable for”, “having the capacity to”, “designed to”, “adapted to”, “made to”, or “capable of”. The term “configured to (or set to)” does not mean only “specifically designed to” in hardware. Instead, the expression “a device configured to” may mean that the device is “capable of” operating together with another device or other components. For example, an “electronic memory assembly” configured to (or set to) store data for subsequent retrieval, refers to any such memory module or modules, with the associated circuitry, power source, and programming which render it capable of performing the corresponding operation of storage and retrieval utilizing a generic-purpose processor (e.g., a central processing unit (CPU) or an application processor) which may perform corresponding operations by executing one or more software programs which are stored on the memory device.

The various illustrative logical blocks, modules and the like described in connection with the present disclosure may be implemented or performed with a general-purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The controller and/or processor refers to a controlling system which typically includes a processor and the related circuitry and components, e.g., power source, memory, storage, processors, coprocessors, gates, relays, other integrated circuits, software, and/or the like, necessary for its function, which is operatively coupled to the other components and/or system of the device. The processor may be responsible for managing general processing, including the execution of software stored on a machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may comprise a computer-readable medium having instructions stored (and/or encoded) thereon, the instructions being executable by one or more processors to perform the operations described herein and be embodied in a computer-program product.

Computer readable medium may also include, by way of example, a carrier wave, a transmission line, and any other suitable medium for transmitting software and/or instructions that may be accessed and read by a computer or the processor. The non-transient computer readable medium may reside in the device, external to the device, or distributed across multiple entities including the device. The non-transient computer readable medium may be embodied in a computer program product. Those skilled in the art will recognize how best to implement the described functionality presented throughout this disclosure depending on the particular application and the overall design constraints imposed on the overall system.

Within the present disclosure, the word “exemplary” and/or “preferably” are used to mean “serving as an example, instance, or illustration.” Any implementation or aspect described herein as “exemplary” and/or “preferably” are not necessarily to be construed as preferred or advantageous over other aspects of the disclosure in an overall limiting sense, but only in relation to specific embodiments. Likewise, the term “aspects” does not require that all aspects of the disclosure include the discussed feature, advantage, or mode of operation.

The terms “circuit” and “circuitry” are used broadly and are intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

In various embodiments of the present disclosure, the electronic components referred to in embodiments of the device are not limited to currently known devices but may include new electronic devices suitable for the intended purpose which are subsequently produced due to the development of new technologies.

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Furthermore, “determining” may include resolving, selecting, choosing, establishing and the like. Likewise, “controlling” encompasses a wide variety of actions, the totality of which results in the functioning of the device for the intended purpose.

For purposes herein, a network refers to two or more network devices coupled, which is referred to herein as “electronic communication” so that signal communications, such as in the form of signal packets, for example, may be exchanged, such as between a server and a client device and/or other types of devices, including between wired devices, wireless devices and/or the like. Unless indicated otherwise, this term (these terms) are used according to their plain and common understanding in the art.

For purposes herein, devices that are “electrically coupled,” in “electric communication” or “electrical communication,” indicate a circuit or path in which electrical energy (current) may flow from one to another. For example, the wireless charging system of the instant application is in electric communication with a power source when power is supplied via wires or conductors, e.g., “plugged in.” Electric communication may be differentiated from “electronic communication,” in that electronic communication involves the transfer of data between two entities, whereas electric communication involves the transfer of electrical power between two entities. The two are not mutually exclusive in that two entities may be in both electronic communication and electric or electrical communication at the same time.

For purposes herein, a cellular network refers to a radio network distributed through cells where each cell includes a fixed location transceiver known as base station. These cells together provide radio coverage over geographical areas. Unless indicated otherwise, this term (these terms) are used according to their plain and common understanding in the art.

As used herein, a local area network (LAN) refers to a collection of devices connected together in one general location, and is not limited in size or scale. A wide area network WAN, also referred to as a metropolitan area network MAN, which covers a larger geographic areas relative to a LAN, and may include any number of LANs. Unless indicated otherwise, these terms are used according to their plain and common understanding in the art.

For purposes herein, an electronic device may include a suitable power receiver, or may be equipped or otherwise associated with a suitable power receiver according to embodiments disclosed herein, e.g., a WiGL power receiver. For example, the WiGL power receiver may be integral to a device and/or may be a dongle or other externally attachable attachment to the electronic device. Unless specified, reference to the electronic device is used interchangeably with the power receiver, e.g., the WiGL power receiver.

For clarity, the following terms should be interpreted according to their plain and common meaning as is readily understood by one of skill in the art, consistent with the following supplemental explanations.

For purposes herein, an “ad hoc” network refers to a network, which may include a data network, a power network, or both, that forms substantially without prior preparation.

For purposes herein, a wireless energy refers to a ray or plurality of rays of electromagnetic radiation energy having a general direction and width. It is to be understood that reference to a wireless energy does not refer to, and is in contrast to power transmission signals made up of power transmission waves, in one or more trajectories by manipulating the phase, gain, and/or other waveform features of the power transmission waves, and/or by selecting different transmit antennas in which the underlying power transmission waves converge at a location in space, resulting in certain forms of interference, one form being “constructive interference,” formed by a field of energy caused by the convergence of the power transmission waves such that they add together and strengthen the energy concentrated at that location establishing a field of energy, or “pocket of energy” at that relative location, and another being “destructive interference” wherein the waves subtract from each other and diminish the energy concentrated at that location.

For purposes herein, a secondary wireless energy refers to a wireless energy transmitted from one transmitter and/or transceiver equipped power receiver to another power receiver.

As used herein, WiGL refers to wireless power grid local area network. A WiGL routing policy refers to a system of defined rules embodied in machine instructions and/or software and/or hardware configured to make and/or guide decisions in transferring wireless energy via wireless energy to electronic devices.

A WiGL routing table refers to a data structure of defined rules accessible by machine instructions and/or software and/or hardware configured to make and/or guide decisions in transferring energy via wireless energy to electronic devices.

For purposes herein, peer-to-peer directional wireless power distribution refers to a power receiver of the wireless charging system further equipped with either a transmitter or a transceiver and is configured to direct at least one secondary wireless energy from a first power receiver towards a determined location of at least one second power receiver.

For purposes herein, a meshed ad hoc wireless power grid local area network refers to a local network topology in which the infrastructure nodes connect directly, dynamically, and non-hierarchically to as many other nodes as possible and cooperate with one another to efficiently route power, or power and data between the base charger and the various clients or nodes on the network.

It is to be understood that reference to a wireless charging system herein also, and simultaneously refers to a wireless power system and/or a wireless power delivery system. Accordingly, although reference is made to a wireless charging system, the system may also deliver power which is utilized to directly power the device subject to the limitations of the system and power receiver e.g., power is received and directed through the intermediary electrical storage device directly to power the attached electronic device.

For purposes herein, it is to be understood that reference to bidirectional electronic communication between any two components of the wireless charging system and/or any component of the wireless charging system and a power receiver, or other outside system or service, may include direct electronic communication, i.e., the component(s) is/are configured for direct electronic communication with the other entity, and/or the component is in electronic communication with the other entity vis-à-vis one or more transmitters, power receivers, and/or transceivers coupled to the wireless charging system, which may further include the system controller.

In embodiments, a method comprises determining a status of a power receiver and/or of an electronic device in communication with the power receiver via bidirectional electronic communication between the wireless charging system and the power receiver and/or between the wireless charging system and the electronic device; transferring wireless energy from the wireless charging system to the power receiver; converting the wireless energy into electrical energy; and directing at least a portion of the electrical energy into a power storage assembly, and/or directly to the electronic device; wherein the transferring of the wireless energy comprises a financial transaction between a wireless energy provider and an end user of the electronic device.

In embodiments, the transferring wireless energy comprises directing an energy beam, non-directional propagation of an RF frequency, non-directional propagation of an ultrasonic frequency, directing of an optical beam, directing of an ultrasonic beam, directing of an infrared beam, directing of an ultraviolet beam, or a combination thereof.

In embodiments, the bidirectional electronic communication between the wireless charging system and the power receiver and/or the electronic device comprises direct and/or indirect electronic communication via: a local area network; an ad-hoc network; a wide area network; a wireless computer network; a wired computer network; a cellular data network; a cellular data network provided at least in part by the electronic device; or a combination thereof.

In embodiments, the bidirectional electronic communication further comprises a request from the power receiver and/or from the electronic device to initiate the transferring wireless energy from the wireless charging system.

In embodiments, the determining a status comprises a determination of one or more physical properties and/or states of the electronic device.

In embodiments, the determination of a status comprises determination of an authorization status, comprising a determination of if the power receiver and/or the electronic device is, or is not authorized to receive wireless energy from the wireless charging system, based on one or more predetermined authorization criteria.

In embodiments, the authorization criteria includes an authorization key, a lookup table, an identifier unique to the power receiver, an identifier unique to the electronic device, a user account, a service subscription, a prepaid subscription, or a combination thereof.

In embodiments, the determining of the authorization status comprises determining if the electronic device is, or is not associated with a user account authorized to receive wireless energy from the wireless charging system, based on one or more predetermined criteria.

In embodiments, the method further comprises causing the electronic device to present an indication perceivable by an end user of the electronic device, indicating the authorization status of the electronic device.

In embodiments, the determining of the authorization status results in the electronic device not being authorized to receive wireless energy from the wireless charging system, the method further comprises causing the electronic device to present an indication perceivable by the end user of the electronic device, and allowing the end user to change the authorization status of the electronic device to being authorized to receive wireless energy from the wireless charging system comprising the financial transaction.

In embodiments, the determining of the authorization status results in the electronic device being authorized to receive wireless energy from the wireless charging system, the method further comprises configuring the power receiver and/or the electronic device to receive the wireless energy from the wireless charging system according to one or more configuration criteria. In embodiments, the configuration criteria includes: a time stamp; a level of charge of the electronic device; an identification variable specific to the electronic device; a receiver frequency; a predetermined criteria; or a combination thereof.

In embodiments, the configuration criteria comprises frequency division multiple access parameter, a time division multiple access parameter, a code division multiple access parameter, an orthogonal frequency division multiple access parameter; and/or a spatial division multiple access parameter.

In embodiments, the configuration criteria is repeatedly updated via the bidirectional electronic communication between the wireless charging system and the receiver and/or between a wireless charging system and the electronic device during the transferring of energy.

In embodiments, the determining of the authorization status results in the electronic device not being authorized to receive the wireless energy from the wireless charging system, the method further comprises configuring the receiver and/or the electronic device to prevent receiving of the wireless energy from the wireless charging system.

In embodiments, the determining of the authorization status results in the electronic device not being authorized to receive the wireless energy from the wireless charging system, the method further comprises configuring the receiver to receive and store electrical energy in the power storage assembly, and to prevent directing of the electrical energy from the power storage assembly to the electrical device.

In embodiments, the financial transaction results in a blockchain permission; a blockchain transaction; an ACH transaction, a bank transaction, a credit transaction, or a combination thereof.

In embodiments is a system configured to conduct any one or more of the methods disclosed herein. In embodiments, a system comprises a wireless charging system comprising one or more power chargers configured to transfer wireless energy from the wireless charging system to a power receiver in electrical communication with an electronic device; the power receiver configured to receive the wireless energy; convert the wireless energy into electrical energy; and direct at least a portion of the electrical energy into a power storage assembly, and/or direct at least a portion of the electrical energy to the electronic device; the system configured to cause a financial transaction to occur between a wireless energy provider and an end user of the electronic device upon the transferring of wireless energy from the wireless charging system to the power receiver.

### The Wireless Charging System

In embodiments, the wireless charging system according to one or more embodiments herein comprises a system controller in electronic communication with at least one base charger. It is to be understood that the system controller and the at least one base charger may be separate components, or may be integrated components, or partially integrated components that may, in embodiments, provide at least some of the same functions. The system controller and/or the base charger are coupled to a power source and at least one transmitting antenna and/or optical transmitter or emitter.

For purposes herein it is to be understood that reference to electronic communication between the wireless charging system and the power receiver may include direct electronic communication between the wireless charging system and the power receiver, direct electronic communication between the wireless charging system and the electronic device associated with the power receiver, electronic communication between the wireless charging system and the electronic device associated with the power receiver through the associated power receiver, electronic communication between the wireless charging system and a second power receiver through one or more first power receivers (peer-to-peer communication), or any combination thereof.

The base charger is configured to emit wireless energy receivable by the power receivers, and which may be received by the power receivers, and the power harvested by the power receivers, at least a portion of which is then converted into a useable source of electrical energy for associated electronic devices and/or at least a portion of which may be utilized for operation of the power receivers and various systems thereof.

The entire wireless charging system is in electrical communication with a power source which may include so called line current e.g., from a power grid, or from a generator solar cell, battery, and/or any other suitable portable energy/power source.

The wireless charging system may also transmit data to, and receive data or other forms of electronic communication from one or more power receivers associated with one or more corresponding electronic or electrically powered devices, an electronic device associated with a power receiver. In embodiments, the wireless base charging system may further include one or more electronic communication (network) components and be in wireless and/or wired electronic communication with one or more of the power receiver, one or more the actual electronic devices associated with a power receiver, as well as various other networks including wireless and/or wired LANs, the internet, intranets, and/or the like. In embodiments, one or more of the system components may also be in wireless or wired electronic communication with other components of the system, e.g., a first of a plurality of base charger may be in wired or wireless electronic communication with another base charger of the same system. In such embodiments, the system controller may be further coupled to one or more transmitters and/or transceivers configured to transmit data to, and receive data or other forms of electronic communication from other electronic devices, as well with other wireless charging systems, other data management systems, databases, managers, service systems, components, and/or the like, as disclosed herein.

In embodiments the directing or transmitting of the wireless energy is conducted using radio frequency (RF) waves. In embodiments, the directing or transferring of the wireless energy includes any form of wireless energy capable of being propagated through space, and that is capable of being converted into a source of electrical energy regardless of the electromagnetic spectrum used. The transmitter or emitter transfers the wireless energy e.g., power, which in embodiments, may include a plurality of transmitters, each of which may transmit a particular form of wireless energy towards a single power receiver.

In embodiments, the wireless energy is in the form of a directional beam. In other embodiments, the wireless energy is in the form of non-directional RF waves. Other exemplary transmission techniques for transferring wireless energy include ultrasound, microwave, resonant and inductive magnetic fields, laser light, infrared, ultraviolet, and/or other forms of wireless energy which may be transmitted as wireless energy, as propagated waves, e.g., resonant energy emitters, or a combination thereof. In addition, the transmitter unit of a base charger may comprise multiple transmitters (e.g., a transmit array), both for RF transmission of power and for other power transmission methods. The base charger may include a plurality of transmit arrays and/or may comprise multiple transmitters that are physically separated from one-another about a physical space, and/or may be located in a single structure.

In some embodiments, the wireless charging system may be configured to scan and/or query a power receiver’s broadcasting advertisement signals or a power receiver may transmit an advertisement signal to the transmitter. The advertisement signal may announce the power receiver’s presence to the transmitter and/or the transmitter may announce its presence to the power receiver.

In one or more embodiments, the advertisement or other signal may communicate information that may be used by various devices (e.g., system controller, base chargers, client devices, sever computers, managers, other power receivers, and the like) to execute and manage the delivery and directing of the one or more wireless energy from at least one transmitting antenna to the location of the power receiver.

Information contained within the advertisement or other communication signal may include a device identifier (e.g., MAC address, IP address, UUID), the voltage of electrical energy received, a client device power consumption, a request from the device for power from the wireless charging system, an authorization status, user or device account information, the type and capability of the power receiver and/or the associated electronic device to receive the wireless energy, pairing information, information directed to the location of the power receiver, changes of location and/or movement of the power receiver, and/or other types of data related to the delivering of wireless energy to the device, and reception of the energy by the electronic device.

In embodiments, the wireless charging system is further configured to utilize information contained in a power receiver’s advertisement and/or request signal, or in subsequent control signals and other electronic communication received from the power receiver, to determine how to direct the wireless power wireless power to the power receiver so that the power receiver may receive, harvest, and utilize the power in the most efficient way.

In embodiments, the wireless charging system comprises a processor or data processing system configured to execute software modules capable of automatically identifying the power transmission signal features needed to deliver wireless power to the power receiver based at least in-part on information received from the power receiver, such as the voltage and/or current produced by the electrical energy harvested by the power receiver from the wireless power. It should be appreciated that the functions of the processor and the software modules may also be implemented at least in part by Application Specific Integrated Circuits (ASIC), or a system comprising the same.

Once the wireless charging system determines if a power receiver is authorized to receive the wireless power, and the power receiver is configured to receive and harvest power from the wireless power, the system is configured to utilize one or more transmitters to begin and/or maintain the directing of wireless power to the power receiver, which may be over a separate channel from the channel over which the bidirectional electronic communication is established (e.g., utilized for communication of various control signals).

In embodiments, the power receiver may generate control data containing information indicating the effectiveness of the transferring of the wireless power by the wireless charging system, e.g., the amount of power being harvested by the power receiver. The power receiver may then transmit or otherwise engage in bidirectional electronic communication with the wireless charging system to transmit and receive various control signals containing control data and the like.

In embodiments, a base charger may power multiple power receivers simultaneously. In embodiments, a plurality of base chargers may transfer wireless power to the same power receiver. In embodiments, the base charger may transfer different types of wireless power, e.g., at different frequencies, and/or using different configurations, from one or more transmitting antenna to a power receiver to increase the amount of power that may be harvested by the power receiver.

The wireless charging system may establish a connection or otherwise associates with a power receiver. That is, in some embodiments, wireless base charging system and/or the system controller and the power receiver(s) may establish wireless unidirectional or bidirectional communication over which various control data is communicated between the two devices over a wireless communication protocol capable of transmitting information between two processors of electrical devices (e.g., Bluetooth®, Bluetooth Low Energy (BLE), Wi-Fi, NFC, ZigBee®). In embodiments, using for example a Bluetooth® or Bluetooth® variant, these data may be used by the base charger to determine the location of the power receiver.

The wireless charging system wireless provides power to the power receiver, which in an embodiment is the result of a request for power from the intended receiver/device, and then to the associated electronic device by transferring wireless power from at least one transmitting antenna to the location of the power receiver.

In embodiments, the wireless charging system forms a wireless power grid local area network comprising one or more base chargers transferring wireless power to power receivers, in which each of the power receivers and base chargers present are nodes of a network. In some embodiments the wireless charging system forms a wireless power grid local area network comprising a peer-to-peer directional wireless power distribution meshed local area network, in which each of the power receivers and base chargers present are nodes of the meshed network, and/or which may be a meshed ad hoc wireless power grid local area network comprising base charger-too-power receiver power distribution and power receiver-too-power receiver power distribution, in which each of the power receivers and base chargers present are nodes of the meshed wireless power grid local area network.

In some embodiments, the electronic communication includes data inputs used by the various antenna elements responsible for controlling production and transmission/directing of the wireless energy. This may include various data signals produced by the power receiver. The electronic communication may be by way of various protocols capable of communicating data between processors, such as Bluetooth®, RFID, infrared, near-field communication (NFC), IEEE 802 standards, “fog” computing standards, edge computing standards, and the like. Such electronic communication may include information between the transmitter and the power receiver used to adjust the power transmission, provide information related to status, efficiency, user data, power consumption, billing, geo-location, authorization, or other status, and/or other types of information.

The bidirectional communication between the wireless charging system and the power receiver may use one or more advertisement or other signals to determine a set of power transmission signal features for transmitting wireless power from at least one transmitting antenna to the location of the power receiver thereby providing power to the power receiver.

In embodiments the method comprises, and or the system is configured to determining of a status of a power receiver and/or of an electronic device in communication with the power receiver via bidirectional electronic communication between the wireless charging system and the power receiver and/or between the wireless charging system and the electronic device; transferring wireless energy from the wireless charging system to the power receiver. In embodiments, the determination of a status comprises determination of an authorization status, comprising a determination of if the power receiver and/or the electronic device is, or is not authorized to receive wireless energy from the wireless charging system, based on one or more predetermined authorization criteria. the determining of the authorization status results in the electronic device being authorized to receive wireless energy from the wireless charging system, the method further comprises configuring the power receiver and/or the electronic device to receive the wireless energy from the wireless charging system according to one or more configuration criteria. In embodiments, the configuration criteria comprises frequency division multiple access parameter, a time division multiple access parameter, a code division multiple access parameter, an orthogonal frequency division multiple access parameter; and/or a spatial division multiple access parameter. Such parameters include directing of the wireless energy and may include phase, gain, timing, frequency division multiple access (multiplexing) (FDMA) parameters, code division multiple access (multiplexing) (CDMA) parameters, polarization division multiple access (multiplexing) (PDMA) parameters, time division multiple access e.g., time division multiplexing (TDMA) parameters, encryption parameters, and the like.

In embodiments, the wireless charging system may use power transmitters incorporating or configured to communications methods such as Wi-Fi, ZigBee, and LAN amongst others. Likewise, the power receivers may include a power receiver application and/or system comprising a BTLE API, a BTLE chip, and/or an antenna array so configured. In embodiments, one or more of the power receiver applications may be an executable program loaded into a non-volatile memory within a power receiver, and/or may include a BTLE API enabling effective interaction between the various components. In embodiments, the antenna array is capable of harvesting power from the wireless power.

### Electronic Communication

In some embodiments, client devices are able to communicate user requests to the wireless charging system e.g., via the system controller, including requests to initiate charging, pause charging, end charging, authorize payment transactions, and the like.

In embodiments, the wireless charging system is configured to undergo a pairing process with one or more power receivers as is commonly understood in the art, to facilitate electronic communication. The pairing process may start when an electronic device is identified by the wireless charging system, and/or when the electronic device requests power from the system or otherwise identifies available power receivers in a system.

In some embodiments, the signal strength of the electronic device may be capable of monitoring the location of the power receiver. In embodiments, the wireless charging system is configured to periodically monitor for the presence of power receivers and/or the location of power receiver(s), and may conduct such pairing with the power receiver when within a range of proximity suitable to perform the pairing. If one of the power receivers is within range the electronic device may proceed to check one or more databases to determine if the power receiver is already paired, authorized for receiving power, and/or the like. If the power receiver is associated with another electronic device, the electronic device may continue to scan for power receivers and track their proximity. If the power receiver has no associations, the wireless charging system may commence the pairing protocol. The process may include the use of timers, sensors, and/or the like to continuously monitor the location of the power receiver. In embodiments, a successful pairing of the power receiver may be recorded and/or update in a corresponding database, associating an electronic device ID with an ID of the associated power receiver. In other embodiments, the wireless charging system is configured to analyze signal strength measurements, efficiencies, usage rates, billing information, conduct analysis and/or compare it with predefined reference values. After updating the information in an internal database, the electronic device may send a copy of the updated database to the power transmitter and pairing process may end. Likewise, the wireless charging system may be configured to execute an un-pairing process wherein the link is terminated.

### Base Charger

The wireless charging system further comprises one or more base chargers capable of transferring wireless energy receivable by the power receivers. Base charges include one or more transmitters/transceivers and/or emitters and their associated components, systems, and the like required to transfer wireless energy towards a location of a power receiver, e.g., in the form of a frequency modulated radio signal on a carrier frequency. The base charger further includes one or more antenna elements, lasers, optical transmitters, ultrasonic transmitters, and/or the like, and may further include one or more RFICs, one or more microcontrollers, one or more communication components, and the like, in electrical connection with a power source. In embodiments, the base charger is disposed within a housing that may include all of the required components. In other embodiments, the base charger may be located in a plurality of housings, and/or may be located within another object or device, e.g., a lamp post, a television, a computer, and/or the like, which is in electrical communication with a power source. The various components of the base charger may comprise, and/or may be manufactured using, meta-materials, micro-printing of circuits, nanomaterials, and the like.

In some embodiments, the wireless charging system comprises multiple base chargers, each of which may comprise multiple transmitters for directing the wireless energy from at least one transmitting antenna to the location of the power receiver. In embodiments, one or more base chargers may further include transmitters/receivers and/or transceivers configured for bidirectional electronic communication between the wireless charging system and a power receiver and/or a client device. These may be the same components utilized for directing power, and/or may be separate devices or configured differently.

In embodiments, the base charger may be configured to transfer wireless energy at a first frequency or frequency range, and/or having a particular first configuration, at the same time direct one or more other wireless energy at one or more other second frequencies or frequency ranges, and/or having a particular second configuration, to the location of the power receiver, thus allowing for an increase in the amount of power a power receiver may receive and harvest.

In embodiments, the base chargers may comprise one or more base controllers which may perform functions for, or instead of the system controller. In addition to the base charger being in electronic communication with the system controller, in some embodiments one or more base chargers may further be in electronic communication with other base chargers, other systems, managers, and/or the like.

### Antenna

In one or more embodiments, the base charger includes one or more transmitting antenna elements, which may be utilized to both transmit the wireless energy and/or be configured for electronic communication. In embodiments, a plurality of antenna elements may be used to transmit the wireless energy, which may be from a single base charger or may be from multiple base chargers associated with the wireless charging system.

Antenna elements of the transmitter may use concepts of wave interference to determine certain wireless energy beam features (e.g., direction of transmission, phase of power transmission signal wave), when transmitting the wireless energy including the use of constructive interference, beam steering, deconstructive interference, reflectance, and the like depending on the topography of a particular physical location.

In embodiments, the wireless energy are formed and transmitted via various beamforming or spatial filtering processes in which one or more digital signals are processed for directional signal transmission and reception by the power receiver. In embodiments, this includes combining elements in an antenna array in such a way that signals at particular angles experience constructive interference while others experience destructive interference. Beamforming can be used at both the transmitting and receiving ends in order to achieve spatial selectivity. In embodiments, the directionality of the antenna array may be configured when transmitting to control the phase and/or relative amplitude of the signal at each transmitter, in order to create a pattern of constructive and destructive interference, which combine to produce wireless energy being directed to the location of the power receiver.

Suitable techniques for use herein include both conventional (fixed or switched beam techniques, adaptive beamforming techniques, e.g., phased array which may include desired signal maximization modes and/or interference signal minimization or cancellation modalities.

Examples of conventional beamformers include the Butler matrix approach which utilizes one or more fixed sets of weightings and time-delays or phasing to combine the signals in the antenna array. Other examples include delay-and-sum transferring of wireless energy wherein a beam is steered by selecting appropriate phases for each of the antenna. Null-steering beamforming techniques may also be used along with frequency-domain beamforming wherein each frequency is treated as a narrowband signal, and the gains and phase shifts are separately optimized for each frequency. Beamforming may further include, and/or the wireless energy may comprise multiple-input multiple-output (MIMO) coding, space-division multiple access (SDMA) coding, frequency division multiple access (FDMA) coding, time division multiple access (TDMA) coding; code division multiple access (CDMA) coding; orthogonal frequency division multiple access (OFDMA) coding; closed loop beamforming, multi-dimensional beamforming, and/or the like.

Examples of suitable adaptive wireless transferring of energy include multiple signal classification algorithms, iterative sparse asymptotic minimum variance algorithms, and the like, wherein information is combined with properties of the signals actually received by the array, typically to improve rejection of unwanted signals from other directions. This process may be conducted in either the time or the frequency domain.

In embodiments, adaptive beamforming is utilized which is configured to automatically adapt and respond to different situations. In embodiments, field programmable gate arrays may be employed along with the appropriate hardware and software. In embodiments, transferring wireless energy may include employing least mean squares (LMS) algorithms, maximum likelihood methods (MLM) algorithms, sample-matrix inversion (SMI) algorithms, recursive least square algorithms, conjugate gradient method algorithms, constant modulus algorithms, and/or the like.

In embodiments, the antenna may include a Digital antenna array (DAA) or other types of smart antenna, comprising multi channels digital beamforming, which may include the use of fast Fourier transform or other algorithms. In embodiments, digital signal processing may be after analog-to-digital converters of receiver channels or before digital-to-analog converters of transmission. Digital signals may be transformed and combined in parallel to produce different output signals, wherein signals energies may be adjusted depending on the location of the intended power receiver. Transferring wireless energy may include signal processing methods, e.g., maximum likelihood beamforming wherein the noise is modeled as a stationary Gaussian white random processes while the signal waveform as deterministic (but arbitrary) and unknown; Bartlett beamforming utilizing various spectral analysis algorithms; Capon beamforming utilizing a minimum-variance distortion less response beamforming algorithm; multiple signal classification beamforming algorithms, ESPRIT algorithms, and/or the like.

Importantly, and in contrast to systems known in the art, the wireless charging system according to embodiments disclosed herein is suitable for functioning in the open, outside of a building or other structure e.g., in plain air. By virtue of transferring wireless energy towards the determined location of the power receiver, the instant system will function to deliver substantial amounts of electrical energy to receivers without relying on the reflection of wireless energy off of walls, furniture, and the like, as is required by other systems to deliver a non-trivial amount to power suitable for charging an electronic device.

In embodiments, the wireless energy have a beam width of less than 360° (for a unidirectional antenna), and less than 180° for a wall mounted or planer antennas. In embodiments, the beams are dynamically adjusted according to the distance from, the base charger, and/or the direction of movement of the intended power receiver. In embodiments, the wireless energy directed to the intended receiver have a beam width of less than or equal to about 60°, or 55°, or 50°, or 45°, or 40°, or 35°, or 30°, or 25°, or 20°, or 15°, or 10°, or 5°.

In one embodiment, the wireless charging system is configured to transfer wireless energy to a power receiver, and/or for one or two way electronic communication between a transmitter/power receiver of the wireless charging system and a transmitter/power receiver of the power receiver within a frequency range, e.g., comprises antenna elements and associated circuitry, software and control systems, for operating in frequency bands from about 20 KHz to about 50 KHz, and/or from about 150 MHz to about 900 MHz, and/or from about 900 MHz to about 1.8 GHz, and/or from about 1.6 GHz to about 2.0 GHz, and/or from about 2.0 GHz to about 8.0 GHz, and/or from about 3 GHz to about 300 GHz.

In an embodiment, the wireless charging system is configured to transfer wireless energy to a power receiver, and/or for one or two way electronic communication between a transmitter/power receiver of the wireless charging system and a transmitter/power receiver of the power receiver within a frequency range, e.g., comprises antenna elements and associated circuitry, software and control systems, for operating in frequency bands of 900 MHz, 2.5 GHz, 5.250 GHz, or 5.8 GHz.

In an embodiment, the wireless charging system is configured to transfer wireless energy to a power receiver, and/or for one or two way electronic communication between a transmitter/power receiver of the wireless charging system and a transmitter/power receiver of the power receiver within a frequency range, e.g., comprises antenna elements and associated circuitry, software and control systems, for operating in frequency bands within the “5G” range which include low-band, mid-band or high-band millimeter-wavelengths having frequencies from about 24 GHz up to 54 GHz, and/or mid-band 5G using microwave wavelengths having frequencies from about 2.3-4.7 GHz, and/or high-band 5G wavelengths using frequencies of 24-47 GHz. These frequencies may be utilized for power transmissions, bidirectional electronic communication between the wireless charging system and a power receiver, or any combination thereof.

In any of such embodiments, the wireless charging system may be configured to transfer wireless energy to a power receiver within a frequency range which is different from the frequency range at which the bidirectional communication between the wireless charging system and the power receiver takes place. For example, the wireless charging system may be configured to transfer wireless energy to a power receiver within a frequency range of less than 3 GHz (below 5G), and conduct bidirectional communication between the wireless charging system and the power receiver at a frequency range at or above 3 GHz (at 5G), and/or the reverse.

In embodiments, one or more of the system antennae comprise a flat panel antenna array, which may be configured for use as a transmitter. The flat panel antenna array may include a number of antenna elements, which in some embodiments comprise from about 64 to 256 antenna elements which may be distributed in an equally spaced grid. For example, the flat panel antenna array may have an 8×8 grid with a total of 64 antenna elements, up to a 16×16 grid to have a total of 256 antenna elements. A plurality of flat panel antenna arrays may also be configured and connected to function as a single, larger flat panel antenna array, e.g., 4 16X16 flat panel antenna arrays may be connected and arranged to function as one 32X32 flat panel array having 1024 elements. The more elements, typically the wider range and higher power transmission capabilities of the antenna. Alternate configurations may also be possible including circular patterns, polygon arrangements, parabolic arrangements, hyperbolic arrangements, and/or the like. The flat panel antenna array may also be broken into numerous pieces or subparts and distributed across multiple surfaces (multi-faceted).

In embodiments, antenna elements of the wireless charging system operate in single array, a pair array, a quad array, or any other suitable number of arrays or arrangement configured in accordance with the desired application. In embodiments, the antenna arrays may include any number of antenna elements capable of transmitting the wireless energy. Generally, with more antenna elements, a wider range and higher power transmission capacity may be achieved. Alternate configurations may also be possible including circular patterns or polygon arrangements, parabolic arrangements, multidirectional arrangements, amongst others.

Suitable antenna elements include flat antenna elements, patch antenna elements, dipole antenna elements, and/or the like which are suitable antennae for wireless energy transmission. The physical dimensions of the antennae including size, shape and orientation vary based on the requirements of the transmitter. In addition, the antennae may comprise a single or multicomponent antenna array arranged to form a three-dimensional special arrangement. Antenna element materials may include any suitable material that may allow radio signal transmission with high efficiency, good heat dissipation and/or the like.

In addition, antenna elements may have at least one polarization or a selection of polarizations. Such polarization may include vertical pole, horizontal pole, circularly polarized, left hand polarized, right hand polarized, or a combination of polarizations. The selection of polarizations may vary in dependency of transmitter characteristics. In addition, antenna elements may be located in various surfaces of the base charger.

In embodiments, the directed wireless energy may be produced within a single frequency range. In other embodiments, the directed wireless energy may be produced within a plurality of frequency ranges either simultaneously, intermittently, or both, being directed from the same base charger, from different base chargers, or from multiple base chargers. The antennas may be optimized to direct the wireless energy depending on the topography of the 3D space, e.g., using dipole antennas for directing power at nearer distances. In some embodiments, the antennas may be capable of manual adjustment to further optimize their efficiency. Likewise, a plurality of channels may be utilized for different types of power transmission and/or electronic communication.

### Power Receiver

In embodiments, the wireless charging system either comprises a power receiver or is configured to function with a power receiver, wherein each power receiver is configured to receive and convert one or more of the wireless energy into electrical energy and provide the energy to the attached electronic device, which in embodiments includes the power receiver being configured to store at least a portion of the electrical energy in an intermediary electrical storage device and release the stored energy to at least one electronic device. The power receiver is further configured to direct electrical energy from the intermediary electrical storage device to a connected electronic device in electrical connection with the power receiver, to charge and/or power the connected electronic device.

The power receiver may be configured for powering or charging a client device is it associated with or coupled to, e.g., via the power receiver having a removable electrical connection with the electronic device, for example in the form of a dongle, within a case, and/or the like. In other embodiments, the power receiver is integrated with and/or within the electronic device.

In embodiments, the power receiver is configured to be removably electrically connected to the electronic device via a disengageable connecter. Suitable electrical connectors include USB connectors, lightning connectors, and the like, configured such that a male end on one of the two engages with a female end of the other to establish electrical and/or electronic communication between the power receiver and the electronic device.

In embodiments, the power receiver comprises one or more receivers capable of receiving and harvesting energy from wireless energy originating from the one or more transmitters of the base charger and/or from another power receiver(s) as discussed in more detail herein.

Power receivers suitable for use herein include at least one antenna element, a receiver controller and/or circuitry configured to harvest power from the wireless energy directed thereto, e.g., rectifying and/or power converting circuitry, and the like. The power receiver further includes one or more electronic communication components. In some embodiments, power converter may include electronic switched mode DC-DC converters, e.g., buck converters of either a step up or step-down arrangement, which can provide high efficiency. The power receiver may comprise one or more capacitors and/or inductors with associated circuitry situated to receive the electrical energy before power converters. The capacitor may ensure sufficient current is provided to an electronic switching device (e.g., switch mode DC-DC converter), so it may operate effectively. When charging an electronic device, for example a phone or laptop computer, initial high-currents that can exceed the minimum voltage needed to activate operation of an electronic switched mode DC-DC converter, may be required. In such a case, a capacitor may be added at the output of the power receiver to provide the extra energy required. Afterwards, lower power can be provided. For example, a few percent of the total initial power that may be used while having the phone or laptop still build-up charge.

The power receiver may comprise a receiver controller in electronic communication with a single antenna or an array of antennas configured to receive the wireless energy from the power transmitter, and the associated circuitry, hardware and programming configured to convert the energy harvested from the wireless energy e.g., the radio frequency electromagnetic radiation, into electrical energy usable by an attached or associated electronic device. In embodiments, the receiver further comprises an intermediate electrical storage device, arranged to receive the harvested power prior to the power being directed to the attached electronic device.

In embodiments, the power receiver incudes at least one rectifier configured to convert the electrical energy from AC to DC. Applicant has discovered that the amount of usable power delivered from an antenna is affected by the impedance of the antenna, and the impedance of associated circuitry, and that the impedance is related to the power and/or the wavelength of the signal received by the antenna. Applicant has discovered that the amount of usable power which may be harvested from a wireless energy is directly related to how well the impedance of the antenna is matched to the impedance of the RF to DC in electrical communication with the antenna. In embodiments, the impedance of the antenna is matched to the impedance of the RF to DC converter and associated circuitry. In one embodiment, this matching is done by means of switching the output of the antenna according to the power being received by the antenna to match the impedance of the RF to DC converter. In other embodiments, the impedance of the RF antenna is dynamically adjusted to match the impedance of the RF to DC converter, and/or the impedance of the RF to DC converter is dynamically adjusted to match the impedance of the RF antenna, based on the power being received by the antenna.

Other types of conditioning may be applied as well. For example, the power receiver may include a voltage conditioning circuit or system which increases or decreases the voltage of the electrical energy as required by the client device. The power receiver may also include a means to control the flow of energy from the intermediate electrical storage device to an associated electronic device e.g, a relay, power transistor, and/or the like with associated circuitry or systems required to convey the electrical energy from the power receiver to an intermediary electrical storage device, and then from the intermediary electrical storage device to the client device.

In embodiments, the power receiver further comprises an antenna configured for power transmission and the associated control systems and circuitry, which may comprise a transmitter/receiver or transceiver configured to both receive and transmit the wireless energy. In embodiments, power receiver comprises one or more transmitter/receiver or transceivers configured for unidirectional or bidirectional electronic communication between and with the wireless charging system or a component thereof, and/or another power receiver, and/or an electronic device associated therewith, which may utilize components of the power transmission circuitry, or may be a stand-alone system, and/or may utilize components and systems of an attached electronic device.

In some embodiments, the power receiver is configured to transmit and/or receive data, e.g., status indications, control signals, and/or the like, too and from the transmitter in order to exchange data in real-time or near real-time. The control signals may contain status information about the client device, the power receiver, an end user of the electronic device, relative to the directing of the wireless energy, authorization status, requests for power, and/or the like. Examples of status information include present location information of the device, an amount of charge received, an amount of charged used, an amount of charge required, user account information, and/or the like.

In some embodiments, the power receiver may be integrated with, and/or configured to utilize components and/or systems conducted by an attached electronic device, integrated into the electronic device, and/or shared with the client device. For example, the power receiver may utilize one or more networking systems of the client device to communicate with the wireless charging system.

The bidirectional electronic communication between the wireless charging system and the power receiver may be conducted intermittently or on an essentially continuous basis, depending on whether the transmitter and power receiver are communicating synchronously (i.e., the transmitter is expecting to receive control data from the power receiver). Additionally, the wireless charging system may transmit the wireless energy to the power receiver, irrespective of whether the wireless charging system and the power receiver are communicating control or other signals.

In some embodiments, the power receiver is configured by the wireless charging system prior to establishing effective harvesting parameters used by the power receiver to allow harvesting of energy from the wireless energy.

Some of the information in the control data may inform the transmitter how to effectively produce and transmit, and in some cases adjust, the features of the wireless energy, begin transmission, update location information, request the wireless charging system to cease power transmission to the power receiver, and/or the like.

In embodiments, a power receiver may be configured to analyze the amount and quality of the power being received and provide information to the wireless charging system directed to adjustments and/or optimization of system.

In embodiments, the power receiver comprises one or more antenna elements, which may comprise any type of antenna capable of transmitting and/or receiving signals in frequency bands used by the wireless charging system. Antenna elements may include vertical or horizontal polarization, right hand or left-hand polarization, elliptical polarization, or other polarizations, as well as any number of polarization combinations. Using multiple polarizations can be beneficial in devices where there may not be a preferred orientation during usage or whose orientation may vary continuously through time, for example a smartphone or portable gaming system. For devices having a well-defined expected orientation (e.g., a two-handed video game controller), there might be a preferred polarization for antennas, which may dictate a ratio for the number of antennas of a given polarization. Types of antennas in antenna elements of the power receiver, may include patch antennas, which may include polarization that depends upon connectivity, i.e., the polarization may vary depending on from which side the patch is fed. In some embodiments, the antenna may be a patch antenna, capable of dynamically varying the antenna polarization to optimize wireless energy transmission.

### Communications Components

In embodiments, the power receiver further includes one or more wireless communication components configured for electronic communication e.g., data, between the power receiver and one or more other devices of the system and/or other power receivers, client devices, and/or the base charger. Different antenna, rectifier or power converter arrangements are possible for a power receiver depending on the intended use. In embodiments, the communications components include those of established or commercial utility, and include those configured for Bluetooth®, Bluetooth Low Energy (BLE), Wi-Fi, NFC, ZigBee®, variants thereof, and/or the like. Such components may be hardware and/or software based, may be present as application specific integrated circuits, and/or incorporated into other components of the system.

### Intermediary Electrical Storage Device

In embodiments, the power receiver further includes an intermediary electrical storage device in electrical communication between a power output of the power receiver and the power input of the electronic device coupled to the power receiver. The power receiver is configured to receive and harvest electrical energy from wireless energy provided by the wireless charging system, which is then provided as a power output of the power receiver. This electrical energy is then directed into the intermediary electrical storage device where it is stored and/or maintained until it is delivered to the power input of the electric device attached or coupled to the power receiver for powering and/or charging of the device, and/or until the power receiver utilizes at least a portion of this power to direct one or more secondary wireless energy to another power receiver.

In embodiments, the intermediary electrical storage device comprises one or more capacitors, inductors, batteries, and/or the like, capable of storing energy that may be then converted into an appropriate DC current and voltage for charging or powering an electric device. In embodiments, the intermediary electrical storage device comprises a capacitor and associated circuitry required to use the capacitor for electrical storage, e.g., timers, resistors, operational amplifiers, transistors, and/or the like.

One significant challenge to providing power wirelessly is that the amount of power that may be transmitted under current regulatory guidelines is less than or equal to one (1) watt, often times much less than one watt. Applicants have discovered that by configuring the power receiver to direct power first into an intermediary electrical storage device, the relatively small amount of power that may be transmitted wirelessly may be stored therein, and when a larger amount of power has been harvested and stored, the power may be released or directed to a load with higher efficiency than would otherwise be possible utilizing the harvested power directly for charging or powering an electronic device.

In addition, the power receiver may be configured to acquire and harvest power autonomously, (regardless of the state of the attached electronic device), such that while the electronic device is not in need of power, the power receiver, by virtue of the intermediary electrical storage device, may be utilized to store energy that will eventually be requested by the device. In addition, the intermediary electrical storage device may be employed to store energy utilized by the power receiver to direct one or more secondary wireless energy to another power receiver in a peer-to-peer power grid arrangement as disclosed herein. Again, this may be done autonomously. The power receiver may also be configured to store energy in the intermediary electrical storage device and only release the same to power or charge the attached electronic device upon the attached electronic device being authorized to receive power from the wireless charging system. This allows for user billing, authentication, and other financial objectives to be obtained, and/ or allow for providing a secure system wherein only authorized devices may utilize power provided by the wireless charging system.

### Peer-To-Peer Wireless Meshed Power Local Area Network

In embodiments, the wireless charging system further comprises or is configured for peer-to-peer power transmission, wherein each power receiver further comprises a transmitter and/or a transceiver in electronic communication with a power receiver controller, configured to direct at least one secondary wireless energy from a first power receiver towards a determined location of at least one second power receiver utilizing a least a portion of the energy stored in the intermediary electrical storage device of the first power receiver, independent of a status of the electronic device in electrical communication with the first power receiver, the second power receiver, or both, the second power receiver configured to receive and convert one or more of the secondary wireless energy into electrical energy and store at least a portion of the electrical energy in a corresponding intermediary electrical storage device of the second power receiver, and to direct electrical energy from the intermediary electrical storage device of the second power receiver to a corresponding attached second electronic device to charge and/or power the attached second electronic device.

In embodiments, the wireless charging system is configured to form a meshed wireless energy grid local area network and/or a meshed ad-hoc wireless energy grid local area network comprising transmission of wireless energy from the base charger too the power receiver, and peer-to-peer directional wireless energy distribution comprising transmission of wireless energy between two or more of the power receivers, wherein the power receivers and the base chargers present are nodes of the meshed network. In this embodiment, the wireless charger system is further configured for bidirectional electronic communication between the base charger and the power receiver, and/or between two or more power receivers, and/or between the base charger and a first power receiver through one or more secondary power receivers. In embodiments, the electronic communication may be conducted via a local area data network, an ad-hoc data network, a wide area data network, a wireless computer network, a meshed network, a wired computer network, intranets, the internet, a radio data network, a cellular data network, a cellular data network provided at least in part by the electronic device or client device, a meshed ad hoc wireless energy grid local area network, or any combination thereof.

Accordingly, by instituting Peer-to Peer wireless energy delivery, the limits of the system, referring to both the amount of power that may be provided and the physical distance or area that may be covered by the wireless charging system, may be larger than the physical area covered by the base chargers. Peer-to-Peer power distribution allows for a nearly infinite area to be serviced, limited only by the presence of power receivers in a concatenation (i.e., a chain) from the edge of the network to the base charger.

As noted above, it is to be understood that reference to bidirectional electronic communication between any two components of the wireless charging system and/or any component of the wireless charging system and a power receiver, or other outside system or service, may include direct electronic communication, i.e., the component(s) is/are configured for direct electronic communication with the other entity, and/or the component is in electronic communication with the other entity vis-à-vis one or more other devices, components, managers, systems, power receivers, and/or transceivers coupled to the wireless charging system, which may further include the system controller. For example, reference to bidirectional electronic communication between the base charger and a power receiver may include the base charger being configured for direct electronic communication, and/or the base charger being communicatively coupled to the wireless charging system controller, and the wireless charging system controller being coupled to one or more electronic communication transmitters, power receivers, and/or transceivers which are separate from the power transmitters, such that the actual communication link between the base charger and the power receiver is through, and/or includes one or more other transmitter/power receiver-transceivers of the wireless charging system, which may further include the system controller and/or other systems, managers, services, and the like.

In some of such embodiments, the wireless charging system is arranged and configured such that the base charger and a first power receiver are in bidirectional electronic communication, wherein the first power receiver and the second power receiver are in bidirectional electronic communication with each other, wherein base charger is in bidirectional electronic communication with the second power receiver through the first power receiver, or a combination thereof, and wherein the base charger is configured to determine if the second electronic device in electrical communication with the second power receiver is, or is not authorized to receive wireless energy from the wireless charging system based on one or more predetermined criteria and wherein the first power receiver is configured such that when the determination of the authorization status results in the first electronic device not being authorized to receive wireless charging from the wireless charging system, the first power receiver is configured to prevent the intermediary electrical storage device of the first power receiver from directing power to the first electronic device in electrical communication with the first power receiver; and direct at least one secondary wireless energy toward the determined location of the second power receiver utilizing a least a portion of the electrical energy stored in the intermediary electrical storage device of the first power receiver.

In embodiments, the wireless charging system is configured and arranged to determine if the electronic device is, or is not authorized to receive wireless energy from the wireless charging system based on one or more predetermined authorization criteria; upon receiving a request from the electronic device and/or receiving a request from a power receiver in electrical connection with the electronic device, which has been determined to be authorized to receive wireless charging from the wireless charging system configuring the power receiver to receive the wireless energy from the wireless charging system according to one or more configuring criteria, transferring wireless energy from the one or more transmitting antennas towards the power receiver of the electronic device at the determined location within the physical space, the power receiver receiving and converting one or more of the wireless energy into electrical energy and storing at least a portion of the electrical energy in an intermediary electrical storage device, and directing the electrical energy from the intermediary electrical storage device to the connected electronic device in electrical connection with the power receiver, to charge and/or power the connected electronic device, wherein upon receiving a request from the electronic device and/or receiving a request from a power receiver in electrical connection with the electronic device which has been determined not to be authorized to receive wireless charging from the wireless charging system, configuring the power receiver to prevent receiving of the wireless energy from the wireless charging system according to one or more configuring criteria; and/or configuring the charging system to prevent transferring wireless energy from the one or more transmitting antennas towards the power receiver of the electronic device at the determined location within the physical space; and/or configuring the power receiver to prevent the directing of electrical energy from the intermediary electrical storage device to the connected electronic device in electrical connection with the power receiver.

In some of such embodiments, the wireless charging system is configured and arranged such that upon receiving a request from the electronic device and/or a power receiver connected to the electronic device, which has been determined to be authorized to receive wireless charging from the wireless charging system: configures one or more other power receivers to direct one or more secondary wireless energy towards the determined location of the power receiver within the physical space; the power receiver receiving and converting one or more of the secondary wireless energy into electrical energy and storing at least a portion of the electrical energy in an intermediary electrical storage device; and directing the electrical energy from the intermediary electrical storage device to the connected electronic device in electrical connection with the power receiver, to charge and/or power the connected electronic device; wherein upon receiving a request from the electronic device and/or power receiver connected to the electronic device which has been determined not to be authorized to receive wireless charging from the wireless charging system: configures the power receiver to prevent receiving of the one or more secondary wireless energy from one or more other power receivers according to one or more configuring criteria; and/or configures the power receiver to prevent the directing of electrical energy from the intermediary electrical storage device to the connected electronic device in electrical connection with the power receiver.

Some embodiments comprise multiple transmitters and/or multiple power receivers for powering a particular piece of electronic equipment, for example smartphones, tablets, music players, toys, and the like, having power requirements which exceed the amount of power providable by the system to a single power receiver.

### Tracking of Receiver Locations - Handoff of Charging

In embodiments, the power receivers harvests energy transmitted from the wireless charging system transmitter(s) that is received into (by) the power receiver’s antenna. The power is then rectified, conditioned, and transferred to the intermediary electrical storage device. In embodiments, the power receiver then sends the resulting electrical energy from the intermediary electrical storage device to the electrically connected device to power or charge the device. In alternative embodiments, the power may be transferred directly to the electrically connected device to power or charge the device. Upon movement of the power receiver from the location (e.g., a first location) to another location (e.g., a second location) the wireless charging system may engage another antenna, and/or another transmitter, and/or configure the transmitter to direct the wireless energy to the second location of the device, thereby “following” the device while providing power thereto via the wireless energy such that the wireless energy remains “aimed” at the location of the power receiver.

### System Managers and User Interfaces

In embodiments, the wireless charging system may further include one or more system or function managers, which may be present as hardware (API) software, virtual, or a combination thereof.

In embodiments, the client or electronic device associated with a power receiver may include, or be configured to utilize a Graphic User Interface (GUI) for managing interactions within wireless charging system. The GUI may be associated with an executable program loaded into a non-volatile memory and/or may be run as a web-based app. In some embodiments, the electronic devices may include a database for storing information related to the power receiver, power status, power schedules, IDs, account information, pairing and any information necessary for receiving power from the wireless charging system. Such a system management GUI may be configured to run on a computer included in, or associated with the wireless charging system, or may run on a remote server that may be in the Internet cloud, an intranet, a fog computing cloud, and/or the like. The system management GUI may provide interaction between the end users or operators and the software within the wireless charging system, and be configured for use in configuration, monitoring, command, control, reporting, and any other system management functionality.

In embodiments, the power receiver and/or the electronic device associated with the power receiver may be configured to determine one or more status, which may include an authorization status, comprising a determination according to one or more authorization criteria of whether or not (if) the electronic device is, or is not authorized to receive wireless energy from the wireless charging system. In embodiments the authorization criteria comprises an authorization key; a lookup table; an identifier unique to the power receiver; an identifier unique to the electronic device; a user account; a service subscription; a prepaid subscription; a blockchain permission; a blockchain transaction; or a combination thereof.

In some of such embodiments, the wireless charging system is configured to cause the electronic device to present an indication perceivable by an end user of the electronic device indicating the authorization status of the electronic device, e.g., via the GUI and/or the GUI is configured to present an indication perceivable by an end user of the electronic device indicating the authorization status of the electronic device based on one or more criteria. In some of such embodiments, the system is configured such that when the determination of the authorization status results in the electronic device not being authorized to receive wireless energy from the wireless charging system, the indication perceivable by the end user allows the end user to change the authorization status of the electronic device.

In one or more embodiments, the GUI or other indication source is configured such that when the end user changes the authorization status of the electronic device, the action comprises, or is designed to result in a financial transaction. In some embodiments, the changing of the authorization status of the electronic device by the end user and/or the like comprises a cryptocurrency financial transaction, a blockchain financial transaction, or a combination thereof.

Likewise, in some embodiments, the when the determination of the authorization status results in the electronic device is not authorized to receive wireless energy from the wireless charging system, the power receiver is configured to prevent the intermediary electrical storage device from directing electrical power to the electronic device in electrical connection with the power receiver.

In embodiments, the determining of the authorization status resulting in a determination that the electronic device is authorized to receive wireless energy from the wireless charging system, the power receiver is configured to receive the wireless energy from the wireless charging system according to one or more configuring criteria, transfer this energy to the intermediary electrical storage device, and then transfer this energy to the associated device e.g., charging a battery and/or directly powering the device.

In embodiments, the GUI and/or system utilizes configuring criteria comprising one or more of a time stamp; a level of charge of the electronic device; an identification variable specific to the electronic device; a power requirement of the electronic device; a predetermined criterion; a multiplexing criterion, or a combination thereof.

In an embodiment, the power receiver is configured to request wireless energy delivery from the wireless charging system based at least in part on a level of charge of the connected electronic device, wherein the level at which a request will be made may be set in the GUI.

In embodiments, the wireless charging system comprises a system controller coupled to one or more base chargers in electronic communication with one or more microprocessors, which may include a wireless energy transmission manager app, system, and/or the like, as embedded software, hardware, or a combination thereof, which may further include an application programming interface e.g., an API, for one or more electronic communication systems and/or protocols, e.g., a Bluetooth Low Energy system or chip. The API may comprise a software application that is run on a mobile, laptop, desktop, server, or other processor equipped computing device. The wireless charging system may further include an antenna manager software or system configured to control an RF antenna array that may be used to deliver the wireless energy.

The wireless charging system may further comprise one or more additional application programming interfaces and or be configured to execute a plurality of functions, including the establishing of a connection, ending a connection, sending data, receiving data, determining a status of a device or power receiver, and the like according to one or more embodiments disclosed herein. Client devices may include a power receiver app or system configured for executing one or more of the functions and/or providing data required by the wireless charging system, an application programming interface, or a combination thereof.

In embodiments the GUI may be a software module that may be downloaded from any application store and may run on any operating system, including iOS and Android, amongst others. The client device may also communicate with the wireless charging system via a one or more communication standards, e.g., Bluetooth, to provide information that may be of use for wireless charging system.

In embodiments, a wireless energy transmission manager system or software may be used in order to manage the directing of wireless energy by the wireless charging system, which may include one or more software modules hosted in memory and executed by a processor inside a computing device. The wireless energy transmission manager system may include a local application GUI, or host a web page GUI, from where a user may see options and statuses, as well as execute commands to manage the wireless charging system. The computing device, which may be cloud-based, fog based, and/or may be connected to the wireless charging system through standard communication protocols, including Bluetooth, Bluetooth Low Energy, Wi-Fi, or ZigBee, amongst others.

The various systems may exchange information with one-another in order to control access by and directing of the wireless energy (power transmission) to power receivers associated with various client devices. Functions controlled by a wireless energy transmission manager system may include scheduling power transmission for individual devices, prioritizing between different client devices, accessing credentials for each client, tracking physical locations of power receivers relative to a base charger, broadcasting messages, determining authorization status, account information, and/or any functions required to manage the wireless charging system.

Computing device may be connected to the wireless charging system through network connections. Network connections may refer to any connection between computers including intranets, local area networks (LAN), virtual private networks (VPN), wireless area networks (WAN), Bluetooth, Bluetooth Low Energy, Wi-Fi, and ZigBee, cellular networks, and/or the like.

### Cloud or Remote Service Providers

In some embodiments, the wireless charging system includes a cloud service provider in electronic communication with the system controller. In embodiments, the cloud service provider includes system controller services, information distribution services, and the like and may be configured, controlled, and monitored via a GUI.

In some implementations, the cloud service provider is electronically coupled to the system controller and/or another component of the wireless charging system. In some embodiments, the cloud service provider is implemented as computer hardware and software including any number of components required for running a desired set of applications, including any number of processors, random access memory modules, physical storage drives, wired communication ports, wireless communication ports, and the like. In an example, the cloud service provider is implemented using one or more components of computing device. In these embodiments, cloud service provider executes any software required to a host system controller and/or the system controller system, including software able to manage user credentials, device identification, device authentication, device authorization, usage and payments associated with one or more users, blockchain transactions, handle service requests, information requests, store and read data related to one or more users, and the like. In other embodiments, cloud service provider additionally includes databases for storing user data, device data, payment data, and the like.

In some embodiments, the system controller is configured to manage power transmission from one or more base chargers to one or more power receivers, credentials associated with mobile device users, billing associated with wireless energy transmissions, and the like. In these embodiments, the system controller is hardware and software configured to issue commands to one or more base chargers, including commands to begin, pause, or stop transmitting power to one or more wireless energy receivers, and the like. In an example, cloud service provider functions substantially similar to computing device, the system controller functions to perform wireless energy management services, or a combination thereof.

In some embodiments, cloud service provider executes any software required to host any information distribution service. Examples of such software include software able to store and read data related to one or more users, perform analytics on data, and the like. In other embodiments, information distribution service is hardware and software configured to collect usage data, billing data, demographic data, and the like from the system controller, base charger, power receiver, and/or client device. Examples of data include total time spent charging, total energy transmitted to a device, average amount of energy delivered monthly to a device, locations where energy has been transmitted to a mobile device, mobile device user demographic descriptors, and the like.

In other embodiments, the system controller is implemented as computer hardware and software including any number of components required for running a desired set of applications, including any number of processors, random access memory modules, physical storage drives, wired communication ports, wireless communication interfaces allowing coupling to antennas, and the like. In an example, the system controller is implemented using one or more components of a computing device.

### Power Transmission Management

In embodiments, the wireless charging system may include one or more power transmission manager functions, which may be configured in hardware, software, or a combination thereof. In embodiments, the power transmission manager functions are conducted by the system controller. In other embodiments, these functions are conducted by a separate integrated power transmission manager system. The power transmission manager functions may also be conducted by remotely located (e.g., cloud based) resources. In other embodiments, a cloud service provider is in communication with one or more base chargers and manages the directing of wireless energy from the one or more base chargers.

In embodiments, one or more application program interface may be used to enable the effective interaction between the wireless charging system, e.g., a wireless energy transmission manager application, and a corresponding application chip or system. For example, a Bluetooth API may be utilized to control a BTLE integrated chip or system.

### Databases

In some embodiments, the wireless charging system may include one or more databases for storing information related to base chargers, power receivers, electronic devices, power status, power schedules, device, and user IDs, pairing, account information, financial transaction information, and/or any information necessary for operation of the system. Database refers to an array of data structures within a computer’s volatile or non-volatile memory but, that is used to organize, store, and retrieve data within the computer of the database. Databases may also be provided by various service providers over various networks, e.g., via secure internet communication. Databases may be implemented through known in the art database management systems (DBMS) such as, for example, MySQL, PostgreSQL, SQLite, Microsoft SQL Server, Microsoft Access, Oracle, SAP, dBASE, FoxPro, IBM DB2, LibreOffice Base, FileMaker Pro and/or any other type of database that may organize collections of data.

In embodiments, the wireless charging system may include one or more databases which may include a distributed system database, which may store relevant information associated with a client device, a client account, identifiers for a client device, voltage ranges for power receivers, location of a client device, signal strength and/or any other relevant information associated with a client device, and/or with a class or type of device according to function, manufacturer, software revision, hardware revision, connection, user preferences, account information, and/or the like. The one or more databases may also store information relevant to the wireless energy local area network, including power receiver ID’s, electronic device ID’s, end-user handheld devices, system management servers, charging schedules, charging priorities, environment topology, and/or any other data relevant to the wireless charging system and/or the WiGL network.

In embodiments, in addition to the wireless charging system forming the wireless energy grid local area network (and/or the ad hoc network, and/or the meshed network), the wireless charging system may further be configured to communicate (electronically) with one or more remote information services, control networks, central locations, e.g.., through a hub and spoke and/or fabric arrangement, via secure hypertext transfer protocols, and/or the like, which in embodiments includes communication via an intranet, the internet, and/or through the internet cloud and/or the like. The one or more remote information services may include financial services, blockchain services, accounting services, control services, maintenance services, security services, and/or the like.

In some embodiments, the wireless charging system may include, and/or may be in electronic communication with one or more back-up servers, e.g., via a local network, the cloud, and/or the like. The wireless charging system may further include a one or more manager systems or software coupled to a distributed system database.

In embodiments, the wireless charging system is configured to obtain, record, store and communicate past system status data, which may include details such as the amount of power delivered to an electronic device, billing information, the amount of energy that was transferred to a group of electronic devices or to an account associated with a user, the amount of time an electronic device has been associated with a base charger, pairing records, activities within the system, any action or event of any wireless energy device in the system, errors, faults, and configuration problems, among others. Past system status data may also include power schedules, names, customer sign-in names, authorization and authentication credentials, encrypted information, physical areas of system operation, details for running the system, financial information, financial transactions, and/or any other system or user-related information.

Present system status data stored in a database may include the locations and/or movements in the system, configuration, pairing, errors, faults, alarms, problems, messages sent between the wireless energy devices, and tracking information, among others.

According to some embodiments, databases associated with the wireless charging system may be configured to determine, store, and communicate future system status information, where the future status of the system may be forecasted or evaluated according to historical data from past system status data and present system status data. Such data may then be utilized by the wireless charging system and/or one or more managers to further enhance and/or optimize system performance and efficiency. In embodiments, these and other data may be utilized (learned from) via artificial intelligence including reactive algorithms, limited memory algorithms, theory of mind algorithms, and/or so-called “self-awareness” algorithms.

In embodiments, one or more machine learning and/or artificial intelligence algorithms are employed to best optimize the amount of power delivered to the devices and minimize the amount of power required by the wireless charging system. In embodiments, the wireless charging system may utilize one or more classification algorithms, e.g., Naive Bayes, decision tree, random forest, support vector machines; K nearest neighbors, and the like; and/or one or more regression algorithms, e.g., linear regression; lasso regression; logistic regression, multivariate regression, multiple regression; and the like.

In some embodiments, the wireless charging system utilizes one or more clustering algorithms, which may include K-Means clustering, fuzzy C-means algorithms, expectationmaximization algorithms, hierarchical clustering algorithms, and/or the like.

In some embodiments, records from all device databases in a wireless charging system may also be stored and periodically updated in one or more servers, in the cloud, and/or the like. In some embodiments, a plurality of wireless charging systems may form a wireless charging system network, and may include two or more servers. In alternative embodiments, a wireless charging system may be a stand-alone or a contained system.

In embodiments, the wireless charging system may further be configured to detect failures in any one of the various systems, e.g., the wireless energy transmission system. Examples of failures in a power transmission system may include overheating of any component, malfunction, and overload, among others. If a failure is detected by the system, the wireless charging system may be configured to analyze the problem and utilize redundant capacity to mitigate and effect, while providing information of the failure to one or more system managers. After the analysis is completed, a recommendation or an alert may be generated and reported to owner of the power transmission system or to a remote cloud-based information service, for distribution to a system owner, manager, manufacturer and/or supplier.

In embodiments, the wireless charging system may further comprise a remote information service or system operated by the owner of the system, the manufacturer or supplier of the system, and/or a service provider. The remote management system may include business cloud, remote manager software or systems, backend servers where the remote manager may further include a general database. Functionality of backend server and remote manager may, in some embodiments, be combined into a single physical or virtual server.

In embodiments, the wireless charging system periodically establish a TCP or some other communication connection with a remote manager and/or the like for authentication, problem report purposes, reporting of status or usage details, and/or the like.

### Methods of Charging Deviceswi

In embodiments, the wireless charging system provides electrical power to one or a plurality of power receiver devices via determining a status of a power receiver and/or of an electronic device in communication with the power receiver via bidirectional electronic communication between the wireless charging system and the power receiver and/or between the wireless charging system and the electronic device; transferring wireless energy from the wireless charging system to the power receiver; converting the wireless energy into electrical energy; and directing at least a portion of the electrical energy into a power storage assembly, and/or directly to the electronic device; wherein the transferring of the wireless energy comprises a financial transaction between a wireless energy provider and an end user of the electronic device.

In one embodiment, the wireless charging system may query the power receiver, and/or provide notice to the power receiver of its presence. The power receiver may then respond, and/or may request power from the wireless charging system. In one embodiment, the wireless charging system then begins transferring wireless energy to the power receiver. The power receiver harvests energy from the wireless energy, and transfers this energy either directly to the electronic device, or to an intermediary storage device, and then directs the energy to the electronic device to charge or power the device.

In an embodiment, bidirectional electronic communication is then established between a transmitter or transceiver of the wireless charging system and a data receiver of the power receiver or transceiver of the power receiver in some embodiments, transmitters and power receivers may communicate control data over using a wireless communication protocol capable of transmitting information between two processors of electrical devices (e.g., Bluetooth®, BLE, Wi-Fi, NFC, ZigBee®). For example, in embodiments implement Bluetooth® or Bluetooth® variants, the transmitter may scan for power receiver’s broadcasting request signals, or a power receiver may transmit an advertisement signal to the transmitter. The request or advertisement signal may announce the power receiver’s presence to the transmitter, and may trigger an association between the transmitter and the power receiver.

In some embodiments, a request or advertisement signal may communicate information that may be used by various devices (e.g., transmitters, client devices, sever computers, other power receivers) to execute and manage the forming and directing of wireless energy to the location of the power receiver. Information contained within the request or advertisement signal may include a device identifier (e.g., MAC address, IP address, UUID), the voltage of electrical energy received, client device power consumption, account information, authorization status information, and other types of data related to power transmission.

The transmitter may use a request or advertisement signal transmitted to identify the power receiver and, in some cases, further locate the power receiver in a two-dimensional space or in a three-dimensional space. Once the transmitter (i.e., the wireless charging system) identifies the power receiver, the transmitter may establish the connection associated in the transmitter with the power receiver, allowing the transmitter and power receiver to communicate control signals over one or more additional channels. The wireless charging system transmitter may also begin directing of the wireless energy, i.e., wireless energy, from antennas of the transmitter’s antenna array directed towards the location of the power receiver.

In embodiments, the power receiver may then measure the voltage, level of charge, and/or the like of the attached device, among other metrics related to effectiveness of the directing of the wireless energy, which may in-turn be compared to the electrical energy received by the power receiver’s antennas. The power receiver may generate control data containing the measured information, and then transmit control signals containing the control data to the transmitter. For example, the power receiver may sample the voltage measurements of received electrical energy, for example, at a rate of 100 times per second. The power receiver may transmit the voltage sample measurement back to the transmitter, 100 times a second, in the form of control signals.

In embodiments, various algorithms of the transmitter and/or the power receiver may be utilized to determine when it is necessary to adjust the transmission parameters and may also vary the configuration of the transmit antennas, in response to determining such adjustments are necessary. For example, the transmitter may determine the power received at a power receiver is less than maximal, based on the data received from the power receiver. The transmitter may then automatically adjust other parameters of the directing of the wireless energy, but may also simultaneously continues to receive and monitor the voltage and/or other metrics being reported back from power receiver.

In embodiments, automated processes performed by the transmitter may select a subset of arrays to direct the wireless energy to the power receiver, and/or other power receivers having power simultaneously supplied by the system.

### System Optimization

As the need for charging of wireless devices increases, the amount of wireless energy in surrounding areas increases proportionality. This results in interference, self-interference, signal jamming, and self-jamming of communication signals. The instant disclosure utilizes a combination of machine learning and artificial intelligence algorithms which identify devices in need of charging, devices authorized to receive charging, and then assign a priority level to these devices. The system then determines the optimal frequency at which to deliver power to the device, and directs wireless energy from at least one transmitting antenna to the location of the receiver of the eligible device in need of charging to charge the device.

In embodiments, the wireless charging system is configured to calibrate and/or configure the antennas transmitting the wireless energy, so that the antennas transmission signals having a more effective or efficient set of features (e.g., direction, beam width, phase, gain, amplitude, frequency, and/or the like). In some embodiments, a processor of the transmitter may automatically determine more effective features for producing and transmitting the wireless energy based at least in-part on one or more control signals received from the power receiver, or other power receivers, which may include historical or machine-learning algorithms.

In some embodiments, the transmitter may execute one or more software modules monitoring the metrics, such as voltage measurements, received from the power receiver. Algorithms may vary production and transmission of directing of the wireless energy by the transmitter’s antennas, to maximize the effectiveness of the directing of the wireless energy to the power receiver and may institute corrections to improve efficiency. When an optimal configuration for the system is identified, memory of the transmitter may store the configurations to keep the transmitter broadcasting at that highest level.

In embodiments, the wireless charging system at least intermittently checks and/or tracks the location of each of the power receivers previously identified, and searches for new power receivers to be added. The tracking and determination of positions may include one or more software packages, and/or employ one or more algorithms in the system controller, utilizing, for example, a CPU, processor, computer among others, for determining the location of each power receiver and the optimal parameters for directing the wireless energy to the location of each of the power receivers. In order to achieve the optimal efficiency of the system, the power receivers and/or the electronic device may be configured to provide feedback to the wireless charging system. Examples include the use of various sensors and/or circuits to determine power efficiency, refine location, identify movement and/or orientation of the device, e.g., via use of an accelerometer, a GPS sensor, and/or the like.

### Power Receiver Initiating Charge

In embodiments, the power receiver may initiate the charging by sending a request for charging to the wireless charging system. In embodiments, the request may be issued based on one or more predetermine criteria such as a level of charge of the device. In some embodiments, the electronic device includes a GUI for interacting with the wireless charging system including issuing a request for charging or power delivery. In other embodiments, the process is automatic as long as particular requirements are met, e.g., the device being authorized to receive charge.

In embodiments, the power receiver and/or the electronic device may be in communication with the wireless charging system and exchange information such as a device ID, a charge status, account information, and/or the like. The wireless charging system controller may update its database and may send a copy to the electronic device including the IDs of available power transmitters within the system. Then, the electronic device may determine if the ID of a device is already associated with the ID of a power receiver, and/or the like.

In some embodiments, this may further include the electronic device and/or the power receiver undergoing a pairing operation with the wireless charging system according to processes known in the art. In embodiments, the electronic device is configured to monitor various parameters, which are communicated to the wireless charging system by either the device or the power receiver attached thereto.

In embodiments, the wireless charging system may configure the power receiver to receive the wireless energy provided. For example, the system controller and/or another system or manager may send information directed to delay encoding, orthogonal frequency-division multiplexing (OFDM), code division multiplexing (CDM) or other binary coding for identifying a given electronic device including the power receiver. The wireless charging system may further authenticate the device and/or power receiver prior to transferring wireless energy toward the location of the power receiver. If the power receiver is not authorized to power receiver power, the wireless charging system may either not deliver power, or prevent power delivered and harvested by the power receiver from being transferred from the intermediary electrical storage device to the power input or battery of the electronic device.

In some embodiments, the wireless charging system is configured to cause the electronic device to present an indication perceivable by an end user of the electronic device indicating the authorization status of the electronic device. In such embodiments, the wireless charging system is configured such that when the determination of the authorization status results in the electronic device not being authorized to receive wireless energy from the wireless charging system, the indication perceivable by the end user allows the end user to change the authorization status of the electronic device. In embodiments, when the end user changing the authorization status of the electronic device comprises a financial transaction, which in some embodiments comprises a cryptocurrency financial transaction, a blockchain financial transaction, or a combination thereof.

In an embodiment wherein the device and/or the power receiver is unknown to the wireless charging system, the wireless charging system may be configured to obtain information from power receiver such as type of device, manufacturer, serial number, total power required, battery level among other such information, and/or invoke or execute one or more programs suited to the authenticate the device. In addition, if multiple power receivers are requiring power, the wireless charging system may deliver power equally to all power receivers or may utilize a priority status for each power receiver. Such a priority status may be user defined and/or may be determined by an account type or status. In some embodiments, the user may choose to deliver more power to its smartphone, than to its gaming device. In other cases, the user may decide to first power its smartphone and then its gaming device.

In embodiments, the wireless charging system may be configured to record data relevant to particular power receivers/devices, and/or groups of power receivers/devices, e.g., powering statistics, timing, how often a device requires power, at what times is the device requesting power, how long it takes to power the device, how much power was delivered to such device, the priority status of devices, the location where is the device was powered, and/or the like. In addition, such statistics and other information could be uploaded to a cloud based or other data server for subsequent use and analysis. In some embodiments, these data may be utilized by the users to forecast the need to buy powering time, for example, a user may pay for an hour of power. Thus, the aforementioned statistics can be used in determining a status, such as and authorization status, of a power receiver and/or a device.

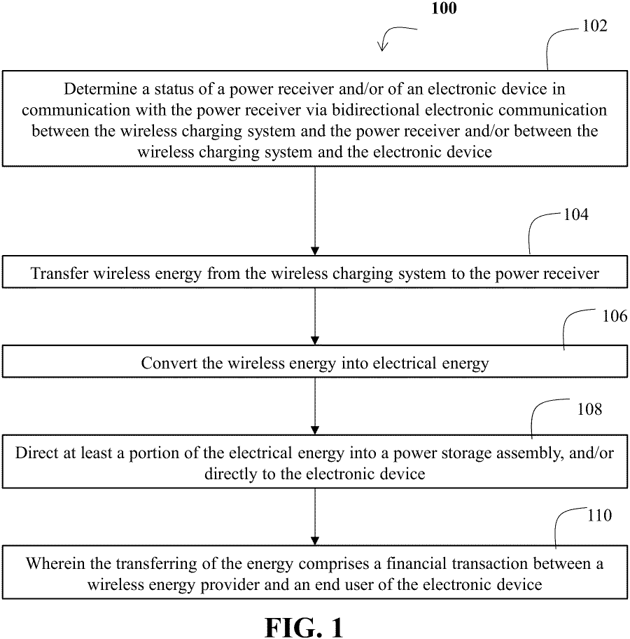

FIG. 1 is a block diagram of an exemplary method according to embodiments disclosed herein. FIG. 1 is a flow chart of a process 100, according to an example of the present disclosure. According to an example, one or more process blocks of FIG. 1 may be performed by device . As shown in FIG. 1, process 100 may include determining a status of a power receiver and/or of an electronic device in communication with the power receiver via bidirectional electronic communication between the wireless charging system and the power receiver and/or between the wireless charging system and the electronic device (block 102). For example, device may determine a status of a power receiver and/or of an electronic device in communication with the power receiver via bidirectional electronic communication between the wireless charging system and the power receiver and/or between the wireless charging system and the electronic device, as described above. As in addition shown in FIG. 1, process 100 may include transferring wireless energy from the wireless charging system to the power receiver (block 104). For example, device may transfer wireless energy from the wireless charging system to the power receiver, as described above. As also shown in FIG. 1, process 100 may include converting the wireless energy into electrical energy (block 106). For example, device may convert the wireless energy into electrical energy, as described above. As further shown in FIG. 1, process 100 may include directing at least a portion of the electrical energy into a power storage assembly, and/or directly to the electronic device (block 108). For example, device may direct at least a portion of the electrical energy into a power storage assembly, and/or directly to the electronic device, as described above. As in addition shown in FIG. 1, process 100 may include where the transferring of the energy may include a financial transaction between a wireless energy provider and an end user of the electronic device (block 110). For example, device may where the transferring of the energy may include a financial transaction between a wireless energy provider and an end user of the electronic device, as described above.

It should be noted that while FIG. 1 shows example blocks of process 100, in some implementations, process 100 may include additional blocks, fewer blocks, different blocks, or differently arranged blocks than those depicted in FIG. 1. Additionally, or alternatively, two or more of the blocks of process 100 may be performed in parallel.

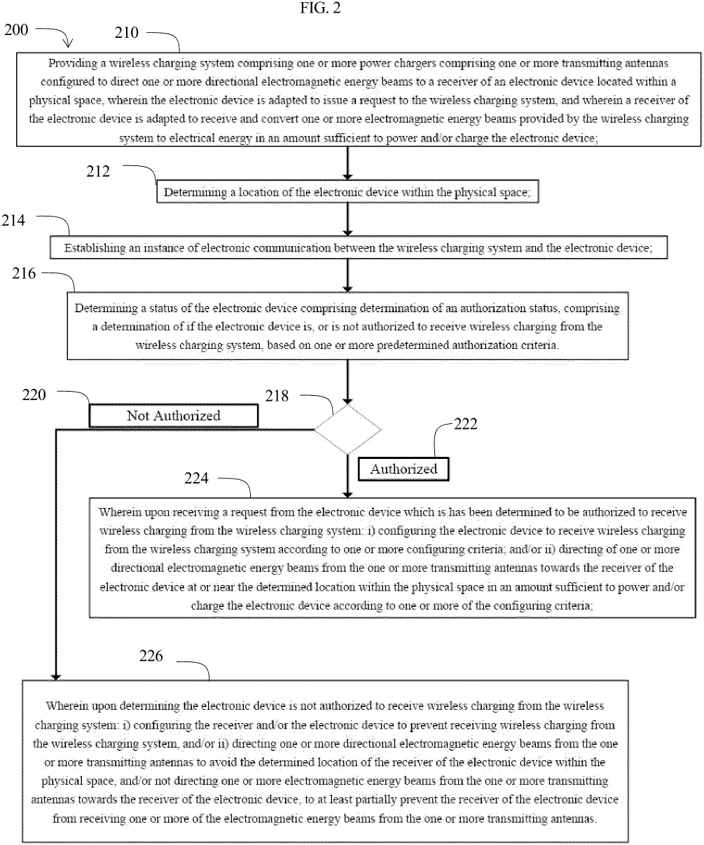

In embodiments, the system determines a status of the electronic device. This status may include a physical property of the electronic device, e.g., a level of charge of the device, information on the brand, capacity, and/or requirements of the device, and/or the like. As shown in FIG. 2, in some embodiments, the method 200 comprises providing a wireless charging system according to one or more embodiments disclosed herein 210, may optionally include determining a location of the electronic device with a physical space of the wireless charging system 212, establishing electronic communication between the wireless charging system and the electronic device 214, and determining of a status of the electronic device 216, which in embodiments comprises determination of an authorization status of the device based on predetermined criteria according to a determination step 218. If the determination of an authorization status of the device returns a negative or “not authorized” status 220, wherein the electronic device is not authorized to receive wireless charging from the wireless charging system, the method may include configuring the power receiver and/or the electronic device to prevent receiving wireless charging from the wireless charging system, and/or transferring wireless energy from the one or more transmitting antennas to avoid the determined location of the power receiver of the electronic device within the physical space, and/or not directing one or more wireless energy beams from the one or more transmitting antennas towards the power receiver of the electronic device, to at least partially prevent the power receiver of the electronic device from receiving one or more of the wireless energy beams from the one or more transmitting antennas 226.

If the determination 218 of an authorization status of the device returns a positive or “authorized” status 222, wherein the electronic device is authorized to receive wireless charging from the wireless charging system, the method may include configuring the electronic device to receive wireless charging from the wireless charging system according to one or more configuring criteria; and/or directing of wireless energy from the one or more transmitting antennas towards the power receiver of the electronic device at or near the determined location within the physical space in an amount sufficient to power and/or charge the electronic device according to one or more of the configuring criteria 224.

This authorization status comprising a determination by the system whether or not the electronic device is authorized to receive wireless charging from the wireless charging system may be based on one or more predetermined authorization criteria. For example, in an embodiment wherein the wireless charging of an electronic device is provided on a fee-based arrangement, such as via subscription. When the system determines that the device is authorized to receive wireless charging from the wireless charging system, a “positive” authorization is obtained. When the system determines that the device is not authorized or unauthorized to receive wireless charging from the wireless charging system, a “negative ″ authorization is obtained.

In embodiments, the determining of the authorization status comprises determining if the electronic device is, or is not associated with a user account authorized to receive wireless charging from the wireless charging system, based on one or more predetermined authorization criteria.

In some embodiments, the authorization criteria include an authorization key, a lookup table, an identifier unique to the electronic device, an indication of the electronic device comprising an active service subscription, an indication of the electronic device comprising an active prepaid subscription, or a combination thereof.

In embodiments, the subscription verification comprises a machine-to-machine (M2M) process. In embodiments, the device to be charged receives a subscription request message for a subscription target resource. In embodiments, the subscription request message contains identification information of the electronic device and/or identification information of the of the wireless charging device. The verification may further include a checking step, wherein the wireless charging system determines whether or not the first device has a right for the subscription target resource.

In embodiments, the process may further include a determination by the wireless charging system whether or not the first device is compatible with, and/or what the optimum parameters are for wireless charging of the first device and/or if the resources are available to the wireless charging system, based at least partially on the identification information of the electronic device.

When the electronic device and the wireless charging device are determined to be compatible, the process may include a step comprising transmitting a notification message to the wireless charging device, the notification message including the identification information of the first device, identification information of the M2M device, and parameter information indicating a verification request; and receiving a response message from the wireless charging device in response to the notification message.

In embodiments, a privilege check for the subscription request may be performed by the wireless charging system based at least partially on the identification information of the first device and the response message may comprise a result of the privilege check performed by the wireless charging device.

In embodiments, the privilege check performed by the wireless charging device includes checking whether or not the first device has a right capable of transmitting a notification message to the wireless charging device. In some embodiments, the privilege check performed by the wireless charging device includes checking whether or not the first device has a right capable of configuring subscription for transmitting a notification message to the wireless charging device.

In one or more embodiments, the process may further comprise transmitting a temporary acceptance message for the subscription request message to the first device before the step of transmitting the notification message to the wireless charging device. In some embodiments, the process may further comprise determining whether or not a result of the privilege check performed by the wireless charging device is successful. When the result of the privilege check is successful, transmitting a subscription grant message to the first device. When the result of the privilege check is failure, cancelling the resource subscription. In embodiments, when the result of the privilege check is failure, transmitting a message for indicating that the resource subscription has been canceled to the first device, which in some embodiments the subscription request message comprises subscription information for creating a subscription resource, which may also include temporarily storing the subscription information.

In some embodiments, the subscription request message may comprise subscription information for creating a subscription resource in the first device. In such embodiments, the process may further comprise creating a subscription resource based on the subscription information.

In embodiments, the identification information of the first device is stored in creator attribute information of the subscription resource and the notification message may be generated when a notification event occurs in the device and the notification event comprises a status change of the subscription target resource. In other embodiments, the notification message is generated in the wireless charging system irrespective of an occurrence of a notification event.

In some embodiments, the identification information of the first device comprises address information indicating an originator of the subscription request message, and the identification information of the wireless charging device comprises address information indicating a notification target of the notification message. In one or more embodiments, the resource corresponds at least in-part to a data structure capable of being uniquely addressed using a unique address. In embodiments, the response message type information of the subscription request message indicates one of a blocking request, a synchronous non-blocking request, or an asynchronous non-blocking request.

In other embodiments, a method for determining and granting access of a device to be charged by the wireless charging system via subscriptions between the wireless charging system and the device may include receiving a subscription request associated with a machine-to-machine configuration, and/or a machine-to-machine network server. Responsive to the receipt of a notification associated with the received request, determining the device associated with the received notification, which may include an originator of the received request; and transmitting, to the device a notification message associated with the received notification. In embodiments, the step of determining includes comparing the received subscription request with at least one previously received subscription and/or comparing the received subscription request with a set of subscribed events stored in a table, e.g., a traffic table and/or the like. In embodiments, the method further includes the step of responding to the originator of the request subsequent to the step of determining. In embodiments, the method includes the step of updating a traffic table to reflect the received subscription. In embodiments, the received request is or comprises a hypertext transfer protocol request.

In embodiments, a method for authenticating a wireless device to be charged includes accessing a network via wireless communication with the wireless charging device. This may include utilizing one or more authentication information elements transmitted between the wireless charging device and the device in a bidirectional exchange involving one or more messages, the one or more authentication information elements including data for use in an authentication handshake procedure involving the one or more messages and for establishing that both the wireless charging device and the device possess a common or specific cryptographic key, and/or one or more of a beacon frame, an association request frame, and an association response frame, and wherein the data includes an arbitrary number that can be used just once in a cryptographic communication, e.g., a “nonce”, for use in an authentication handshake procedure; and a message integrity check value for use in the authentication handshake procedure. In embodiments, the method may further comprise receiving one or more further authentication information elements received by one or more of the devices, which may be based on exchange of the one or more authentication information elements and the one or more further authentication information elements.

In embodiments, one or more authentication information elements are transmitted from the device to the wireless charging device.

In embodiments, at least some of the steps performed are done in parallel with the authentication procedure. In embodiments, the data includes a key identifier indicative of which key of a plurality of pre-shared keys is to be used in the authentication procedure. In some embodiments, the authentication procedure comprises transmitting a first authentication information element from the wireless charging device to the device, the first authentication information element including a first nonce value; subsequently transmitting a second authentication information element from the device to the wireless charging device, the second authentication information element including a second nonce value and a Message Integrity Check value; and subsequently transmitting a third authentication information element from the wireless charging device to the device, the third authentication information element including a further Message Integrity Check value, wherein the authentication information elements include the first authentication information element and the third authentication information element; or the second authentication information element.

In embodiments, the data between the wireless charging device and the device to be charged includes one or more uniform resource identifiers, a timestamp parameter, or a combination thereof.

In embodiments, the system and/or the method further comprises causing the electronic device to present an indication perceivable by an end user of the electronic device, indicating the authorization status of the electronic device. This may be via a network transmission originated by the wireless charging system to the electronic device, or originated by an ancillary device associated with the wireless charging system, e.g., an access control server or other access control function or system. The indication may be via text (SMS) message, may result in a graphic message displayed on the electronic device, an automated telephone call, a haptic indication, and/or the like.

In some embodiments, wherein the determining of the authorization status results in the electronic device not being authorized to receive wireless charging from the wireless charging system, a negative authorization result, the method further comprises causing the electronic device to present an indication perceivable by the end user of the electronic device. In some embodiments the method further comprises allowing the end user to change the authorization status of the electronic device to being authorized to receive wireless charging from the wireless charging system.

In some embodiments, allowing the end user to change the authorization status of the electronic device to being authorized to receive wireless charging from the wireless charging system comprises a request for, and a verification of a financial transaction which ultimately results in a transfer of funds. This may include a conventional currency operated device wherein the intended end user may provide currency directly to a recipient device and/or a card-operated device whereby the user paying by card is connected to a credit card transaction center to obtain an authorization code. This may also include the use of prepaid cards and other RFID credit cards for paying small amount offline without the need of signing a credit card voucher. This may include cryptocurrency, blockchain currency or transactions, and/or the like.

In other embodiments, and authorization payment may be made via one or more online payment methods, e.g., PayPal, via communication with a bank account direct debit system and a back-end pay-by-phone server computer system, and/or the like so that fees can be directly debited from users’ bank accounts, credit card accounts, or telephone payment accounts. In this manner, a user can have multiple payment options including swiping a contactless IC prepaid card, via a contactless IC card reader unit or paying by dialing a cell phone via the remotely controllable pay-by-phone unit according to commonly understood systems known in the art.

In embodiments, wherein the determining of the authorization status results in the electronic device being authorized to receive wireless charging from the wireless charging system (a positive authorization result), the method further comprises and/or the system is configured to configure the electronic device (or the power receiver associated with the electronic device) to receive wireless charging from the wireless charging system according to one or more configuring criteria. This may include providing various frequencies to the device, and/or switching of various frequencies of the wireless energy directed to the device according to a predetermined schedule.

In a related embodiment, the wireless energy beams is not directed to the device, or is only partially directed to the device, but is instead broadcast to an entire area. The ability of the device to receive the wireless charging is controlled by switching of the various frequencies and/or utilizing packet switching and/or the like according to a schedule determined by the wireless charging system and/or the electronic device to enable the electronic device to receive adequate power for charging.

In embodiments, a positive authorization result includes the method or the system being configured to directing of wireless energy from the one or more transmitting antennas towards the power receiver of the electronic device at or near the determined location within the physical space in an amount sufficient to power and/or charge the electronic device according to one or more of the configuring criteria, as compared to a negative authorization result wherein directing the wireless energy beam in the direction of, or to the location of the unauthorized device is avoided. In doing so, at least a portion of the energy that would be received by an authorized device is prevented from being received by an unauthorized device.

In some embodiments, the determining of a status comprises a determination of one or more physical properties and/or states of the electronic device, and directing of the wireless energy from the one or more transmitting antennas towards the power receiver of the electronic device at or near the determined location within the physical space in an amount sufficient to power and/or charge the electronic device, based on at least one of the physical properties and/or states of the electronic device and/or based on one or more predetermined criteria.

In some embodiments, wherein the authorization status results in the electronic device not being authorized to receive wireless charging from the wireless charging system, the method further comprises and/or the system is configuring to configure the power receiver and/or the electronic device to prevent receiving wireless charging from the wireless charging system. This may be achieved via a network connection, and/or may be included in or in unison with the electromagnetic beam directed towards the electronic device.

Likewise, wherein a negative authorization status is determined, the method further comprises or the system is configured to transfer wireless energy from the one or more transmitting antennas to avoid the determined location of the power receiver of the unauthorized electronic device within the physical space, and/or the system stops directing one or more wireless energy beams from the one or more transmitting antennas towards the power receiver of the electronic device, to at least partially prevent the power receiver of the electronic device from receiving one or more of the wireless energy beams from the one or more transmitting antennas.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

We claim:

1. A method comprising:
determining a status of a power receiver and/or of an electronic device in communication with the power receiver via bidirectional electronic communication between the wireless charging system and the power receiver and/or between the wireless charging system and the electronic device;
transferring wireless energy from the wireless charging system to the power receiver;
converting the wireless energy into electrical energy; and
directing at least a portion of the electrical energy into a power storage assembly, and/or directly to the electronic device;
wherein the transferring of the wireless energy comprises a financial transaction between a wireless energy provider and an end user of the electronic device.

2. The method of claim 1, wherein the transferring wireless energy comprises directing an energy beam, non-directional propagation of an RF frequency, non-directional propagation of an ultrasonic frequency, directing of an optical beam, directing of an ultrasonic beam, directing of an infrared beam, directing of an ultraviolet beam, or a combination thereof.

3. The method of claim 1, wherein the bidirectional electronic communication between the wireless charging system and the power receiver and/or the electronic device comprises direct and/or indirect electronic communication via:
a local area network;
an ad-hoc network;
a wide area network;
a wireless computer network;
a wired computer network;
a cellular data network;
a cellular data network provided at least in part by the electronic device;
or a combination thereof.

4. The method of claim 1, wherein the bidirectional electronic communication further comprises a request from the power receiver and/or from the electronic device to initiate the transferring wireless energy from the wireless charging system.

5. The method of claim 1, wherein the determining a status comprises a determination of one or more physical properties and/or states of the electronic device.

6. The method of claim 1, wherein the determination of a status comprises determination of an authorization status, comprising a determination of if the power receiver and/or the electronic device is, or is not authorized to receive wireless energy from the wireless charging system, based on one or more predetermined authorization criteria.

7. The method of claim 6, wherein the authorization criteria includes an authorization key, a lookup table, an identifier unique to the power receiver, an identifier unique to the electronic device, a user account, a service subscription, a prepaid subscription, or a combination thereof.

8. The method of claim 6, wherein the determining of the authorization status comprises determining if the electronic device is, or is not associated with a user account authorized to receive wireless energy from the wireless charging system, based on one or more predetermined criteria.

9. The method of claim 6, further comprising causing the electronic device to present an indication perceivable by an end user of the electronic device, indicating the authorization status of the electronic device.

10. The method of claim 6, wherein the determining of the authorization status results in the electronic device not being authorized to receive wireless energy from the wireless charging system, the method further comprises causing the electronic device to present an indication perceivable by the end user of the electronic device, and allowing the end user to change the authorization status of the electronic device to being authorized to receive wireless energy from the wireless charging system comprising the financial transaction.

11. The method of claim 6, wherein the determining of the authorization status results in the electronic device being authorized to receive wireless energy from the wireless charging system, the method further comprises configuring the power receiver and/or the electronic device to receive the wireless energy from the wireless charging system according to one or more configuration criteria.

12. The method of claim 11, wherein the configuration criteria includes:
a time stamp;
a level of charge of the electronic device;
an identification variable specific to the electronic device;
a receiver frequency;
a predetermined criteria;
or a combination thereof.

13. The method of claim 11, wherein the configuration criteria comprises frequency division multiple access parameter, a time division multiple access parameter, a code division multiple access parameter, an orthogonal frequency division multiple access parameter; and/or a spatial division multiple access parameter.

14. The method of claim 11, wherein the configuration criteria is repeatedly updated via the bidirectional electronic communication between the wireless charging system and the receiver and/or between a wireless charging system and the electronic device during the transferring of energy.

15. The method of claim 6, wherein the determining of the authorization status results in the electronic device not being authorized to receive the wireless energy from the wireless charging system, the method further comprises configuring the receiver and/or the electronic device to prevent receiving of the wireless energy from the wireless charging system.

16. The method of claim 6, wherein the determining of the authorization status results in the electronic device not being authorized to receive the wireless energy from the wireless charging system, the method further comprises configuring the receiver to receive and store electrical energy in the power storage assembly, and to prevent directing of the electrical energy from the power storage assembly to the electrical device.

17. The method of claim 1, wherein the financial transaction results in a blockchain permission; a blockchain transaction; an ACH transaction, a bank transaction, a credit transaction, or a combination thereof.

18. A system comprising:
a wireless charging system comprising one or more power chargers configured to transfer wireless energy from the wireless charging system to a power receiver in electrical communication with an electronic device;
the power receiver configured to receive the wireless energy;
convert the wireless energy into electrical energy; and
direct at least a portion of the electrical energy into a power storage assembly, and/or direct at least a portion of the electrical energy to the electronic device;
the system configured to cause a financial transaction to occur between a wireless energy provider and an end user of the electronic device upon the transferring of wireless energy from the wireless charging system to the power receiver.
